(19) United States
(12) Patent Application Publication
(10) Pub. No.: US 2018/0208352 A1
(43) Pub. Date: Jul. 26, 2018

(54) Apparatuses and Methods for Packaging Surfboards and Other Objects

(71) Applicant: Michiaki Ishida, Dana Point, CA (US)

(72) Inventor: Michiaki Ishida, Dana Point, CA (US)

(21) Appl. No.: 15/390,689

(22) Filed: Dec. 26, 2016

Related U.S. Application Data
(60) Provisional application No. 62/271,267, filed on Dec. 27, 2015.
(60) Provisional application No. 62/396,722, filed on Sep. 19, 2016.

(51) Int. Cl. B65D 5/50; B65D 85/00; B65D 85/64; B31B 50/26; B63B 35/79

(52) U.S. Cl. CPC B65D 5/5028; B65D 85/54; B65D 2585/649; B31B 50/26; B63B 35/7946; B65D 85/64

(57) ABSTRACT

An apparatus for packaging at least one surfboard includes an outer enclosure. The packaging apparatus further includes a plurality of edge frames supported directly or indirectly by the outer enclosure. The edge frames are configured to support the surfboard, directly or indirectly. Optionally, the packaging apparatus may also have a plurality of stabilizers affixed to the outer enclosure, where the plurality of edge frames have at least a first edge frame and a second edge frame, the first edge frame abuts at least two of the plurality of stabilizers, and the second edge frame abuts at least two of the plurality of stabilizers.

### CLAIM FOR PRIORITY

This application claims priority under 35 U.S.C. § 119(e) to Provisional Application No. 62/271,267, filed Dec. 27, 2015, and Provisional Application No. 62/396,722, filed Sep. 19, 2016, both of which are incorporated herein by reference in their entireties.

### TECHNICAL FIELD

This application relates to apparatuses and methods for packaging surfboards as well as similar and/or related objects, to, for example, facilitate their shipping, storage, and protection.

### BACKGROUND

Surfboards are typically bulky, heavy objects, with a shape that can be awkward for packaging, which is typically required for shipping, storage, and protection. This can make the prospect of packaging surfboards difficult, time-consuming, and expensive. Further, such difficulties may be compounded when it is desired for a surfboard to be packaged along with a second (or further additional) surfboards or related objects, such as a paddle for a stand-up paddle surfing (SUP) board.

Thus, there is a need for improved apparatuses and methods for packaging surfboards and related objects that are easier, quicker, and/or cheaper than those currently used.

### SUMMARY

In one embodiment, an apparatus for packaging at least one surfboard comprises an outer enclosure. A plurality of edge frames are supported directly or indirectly by the outer enclosure. The edge frames are configured to support the surfboard, directly or indirectly.

In another embodiment, a plurality of stabilizers are affixed to the outer enclosure. The plurality of edge frames comprise at least a first edge frame and a second edge frame. The first edge frame abuts at least two of the plurality of stabilizers; and the second edge frame abuts at least two of the plurality of stabilizers.

It is to be understood that both the foregoing general description and the following detailed description are exemplary and explanatory only and are not restrictive of the invention as claimed.

### BRIEF DESCRIPTION OF THE DRAWINGS

The accompanying drawings, which are incorporated in and constitute a part of this specification, and, together with the description, illustrate several embodiments and aspects of apparatuses and methods described herein.

FIGS. 1A, 1B, and 1C are diagrams illustrating an embodiment of horizontal surfboard packaging for a single surfboard and steps of an exemplary method of assembling the same.

FIGS. 2A, 2B, and 2C are diagrams illustrating an embodiment of horizontal surfboard packaging for two surfboards and steps of an exemplary method of assembling the same.

FIGS. 3A, 3B, and 3C are cross-sectional front, top, and side views, respectively, of an embodiment of horizontal surfboard packaging consistent with that depicted in FIGS. 1A, 1B, and 1C.

FIGS. 4A, 4B, and 4C are cross-sectional front, top, and side views, respectively, of an embodiment of horizontal surfboard packaging for a single surfboard.

FIGS. 5A, 5B, and 5C are cross-sectional front, top, and side views, respectively, of an embodiment of horizontal surfboard packaging consistent with that depicted in FIGS. 2A, 2B, and 2C.

FIGS. 6A, 6B, and 6C are cross-sectional front, top, and side views, respectively, of an embodiment of horizontal surfboard packaging for two surfboards.

FIGS. 7A, 7B, 7C, 7D, 7E, 7F, 7G, 7H, 7I, and 7J are diagrams illustrating embodiments of selected surfboard packaging components consistent with those depicted in FIGS. 1A, 1B, and 1C and FIGS. 3A, 3B, and 3C.

FIGS. 8A and 8B are diagrams illustrating front and side views of an embodiment of a surfboard packaging component consistent with the embodiment depicted in FIGS. 4A, 4B, and 4C.

FIGS. 9A, 9B, 9C, 9D, 9E, 9F, 9G, 9H, 9I, 9J, 9K, and 9L are diagrams illustrating embodiments of selected surfboard packaging components consistent with embodiments depicted in FIGS. 2A, 2B, and 2C and FIGS. 5A, 5B, and 5C.

FIGS. 10A, 10B, 10C, 10E, 10F, and 10G are views and diagrams of portions of an embodiment of horizontal surfboard packaging and an exemplary method of assembling parts thereof.

FIGS. 10D, 10H, 10I, 10J, 10K, 10L, 10M, 10N, and 100 are diagrams illustrating embodiments of selected surfboard packaging components consistent with the embodiments depicted in FIGS. 10A, 10B, 10C, 10E, 10F, and 10G.

FIGS. 11A, 11B, and 11E are cross-sectional top, side, and front views, respectively, of an embodiment of horizontal surfboard packaging for a single surfboard.

FIGS. 11C and 11D are diagrams illustrating an exemplary method of assembling portions of the embodiment depicted in FIGS. 11A, 11B, and 11E.

FIGS. 12A, 12B, and 12C are cross-sectional top, side, and front views, respectively, of an embodiment of horizontal surfboard packaging for two surfboards.

FIGS. 13A, 13B, and 13C are cross-sectional top, side, and front views, respectively, of an embodiment of horizontal surfboard packaging for a single surfboard.

FIGS. 14A, 14B, and 14C are cross-sectional top, side, and front views, respectively, of an embodiment of vertical surfboard packaging for a single surfboard.

FIGS. 15A, 15B, and 15C are cross-sectional top, side, and front views, respectively, of an embodiment of vertical surfboard packaging for two surfboards.

FIGS. 16A, 16B, and 16C are diagrams illustrating an embodiment of surfboard packaging for a single surfboard and steps of an exemplary method of assembling the same.

FIGS. 17A, 17B, and 17C are diagrams illustrating an exemplary method of packing and loading packages for shipping, according to an embodiment.

FIGS. 18A, 18B, 18C, 18D, 18E, 18F, 18G, 18H, 18I, 18J, 18K, and 18L are views of various embodiments of edge frames.

FIGS. 19A, 19B, and 19C are views of an embodiment of an edge frame assembled from a single piece of cardboard.

FIGS. 19D, 19E, 19F, 19G, 19H, 19I, and 19J are diagrams illustrating exemplary steps of method of assembling the edge frame embodiment depicted in FIGS. 19A, 19B, and 19C.

FIGS. 20A, 20B, and 20C are cross-sectional top, side, and front views, respectively, of an embodiment of vertical surfboard packaging for a single surfboard.

FIGS. 21A, 21B, and 21C are cross-sectional top, side, and front views, respectively, of an embodiment of vertical surfboard packaging for a single surfboard and a paddle.

FIG. 21D is a view of an embodiment of an edge frame consistent with the embodiment of FIGS. 21A, 21B, and 21C.

FIG. 22 is a diagram illustrating an embodiment of vertical surfboard packaging for a single surfboard.

FIG. 23A is a diagram illustrating an embodiment of vertical surfboard packaging for a single surfboard and steps of an exemplary method of assembling the same.

FIGS. 23B and 23C are diagrams illustrating alternative edge frame placements consistent with the embodiment of FIG. 23A.

FIG. 24 is a diagram illustrating an embodiment of vertical surfboard packaging for a single surfboard and steps of an exemplary method of assembling the same.

FIG. 25A is a diagram illustrating an embodiment of vertical surfboard packaging for a single surfboard without edge frames.

FIG. 25B is a view of an embodiment of a vertical bracket insert consistent with the embodiment of FIG. 25A.

FIG. 25C is a diagram illustrating elongated edge cushions on a surfboard consistent with an embodiment.

FIG. 25D is a diagram illustrating an embodiment of vertical surfboard packaging for a single surfboard with edge frames and bracket inserts.

FIG. 25E is a view of an embodiment of a vertical bracket insert with edge frames consistent with the embodiment of FIG. 25D.

FIG. 26 is a diagram illustrating an embodiment of vertical surfboard packaging for a single surfboard and steps of an exemplary method of assembling the same.

FIGS. 27A, 27B, 27C, and 27D are diagrams illustrating steps of an exemplary side-loading method of assembling an embodiment of vertical surfboard packaging.

FIG. 28 is schematic side view of an embodiment of surfboard packaging for multiple surfboards with nested bracket inserts.

### DETAILED DESCRIPTION

Packaging apparatuses and methods are described for packaging physical objects and loading packages containing such objects for shipping, storing, and protecting the objects from damage. The packaging apparatuses and methods may be used to package various physical objects having different possible sizes and shapes and made of different materials, including, for example, mechanical devices and electronic devices; and may be particularly advantageous for physical objects that have elongated rectangular, roughly rectangular, or prism shapes. For example, the packaging systems and methods may be particularly useful for physical objects that have a relatively high length-to-width ratio and/or are substantially planar. Various components of the packaging 100 may be provided or sold separately or in combination. For example, the components may be sold in a modular or “a la carte” fashion.

In certain exemplary embodiments, packaging 100 (or “package 100”) is used to package one or more surfboards 1. “Surfboards” include, but is not limited to, traditional surfboards, windsurfing boards, stand-up paddle surfing (SUP) boards, paddle boarding boards, snow boards, and other buoyant platforms used to enable people or other animals to traverse bodies of water, snow, or sand. For example, certain embodiments described herein may be used for packaging a stand-up paddle (SUP) system that includes include a surfboard 1 and a paddle 5 in a single package 100. In other versions, the packaging 100 may be used to package electronic devices, mechanical apparatuses, and other items. The packaging 100 may be particularly advantageous for elongated, substantially planar, roughly rectangular-prism-shaped objects, and/or objects with dimensions akin to surfboards.

Packaging 100 may include an outer enclosure 101 and may also include an infrastructure to support the one or more objects, such as wholly inside the outer enclosure. The packaging 100 may partially or wholly enclose and protect surfboard 1 or other objects inside the packaging. One or more components of outer enclosure 101 and the infrastructure (e.g., the frames, braces, additional protections, cushions, fastening straps 170, stabilizers 180, and/or bracket inserts, all described below) may be shaped, sized, and/or its components selected and positioned to fit surfboards 1 or other objects of a particular shape and size.

Outer enclosure 101 and/or the components of the infrastructure may be made of cardboard, molded plant fiber pulp (e.g., Eco Flex Molded Pulp or Globe Guard Eco Flex), plastic (such as recycled plastic, substantially hollow plastic, lightweight plastic, polypropylene, and/or polystyrene foam or another type of foam), “egg carton” material, or another suitable material. For example, outer enclosure 101 may be constructed of one or more layers of polypropylene. As another example, one or more of the components of packaging 100, such as, for example, outer enclosure 101, infrastructure, and handle of packaging 100 may be made of reusable and/or recyclable material. These component materials may also have any of various suitable constructions or configurations, such as, for example, flat, corrugated, waffled, or honeycomb. Furthermore, these components may be modular and interlockable with one another, such as to fit differently sized or shaped surfboards 1 and/or other object(s) to be packaged.

In certain embodiments, surfboard 1 or other object(s) to be packaged may be oriented “vertically” in packaging 100, with its “short” axis (e.g., an axis perpendicular to the longitudinal axis, but not the axis corresponding to the thickness of the surfboard or object) at a substantially 90-degree angle to the surface of the ground and with the longitudinal axis of the object(s) being substantially parallel to the surface of the ground. In other words, packaging 100 may be best adapted for shocks when the object is laid upright against the direction of gravity. Such a vertical position may be advantageously practical, for example, for shipping and/or storage.

In other embodiments, surfboard 1 or object(s) to be packaged are oriented horizontally in packaging 100. “Horizontally” means that the “short” axis of the object(s) is substantially parallel to the surface of the ground; in other words, horizontal packaging 100 may be best adapted for shocks when the object is laid as flat as possible in the direction of gravity.

Outer enclosure 101 of packaging 100 may comprise one or more boxes, that in turn may be comprise of one, two, or more cardboard layers or other suitable materials. Each layer of the boxes may be constructed of single-wall, double-wall, or triple-wall corrugated material. Strap, tapes, staples, glues or other similar fastening means may be used to fasten the boxes of outer enclosure 101, especially where mounted frames are located within the enclosure for support. When multiple boxes are used, one or more of cushions may be inserted between the boxes for enhanced protection and fitting and fastening. In packaging 100, one or more of the components of the infrastructure may optionally protrude from one or more of the cardboard boxes of outer enclosure 101. Further, a handle may be added to the packaging, such as to outer enclosure 101.

The infrastructure may include frames (or “mounting structures” or “mounting bases”) to support and/or buttress the surfboard 1 or object(s), such as against other frames, the inner surface of outer enclosure 101, cushions, or against another object inside the packaging. The frames may be, in part or whole, contoured to the shape of the object(s) that abut them. The frames may be made of cardboard, molded pulp, plastic (such as recycled plastic, substantially hollow plastic, lightweight plastic, durable plastic, polypropylene, and/or polystyrene foam or another type of foam), or another suitable material. The frames may be constructed in a multilaminar, composite, or molded fashion. For example, if the frames are made of cardboard, three or more layers of cardboard material may be glued together to form a sandwiched structure, or a frame may be folded from a single layer of cardboard.

The frames may be secured against the inner surface of outer enclosure 101 and/or the object(s) to be packaged. Additionally or alternatively, the frames may have a contoured surface that is shaped to fit around the object(s) to be packaged, or be adjustable in the shape (such as concave) and/or thickness to fit the shape or size of the abutting object(s) to be packaged.

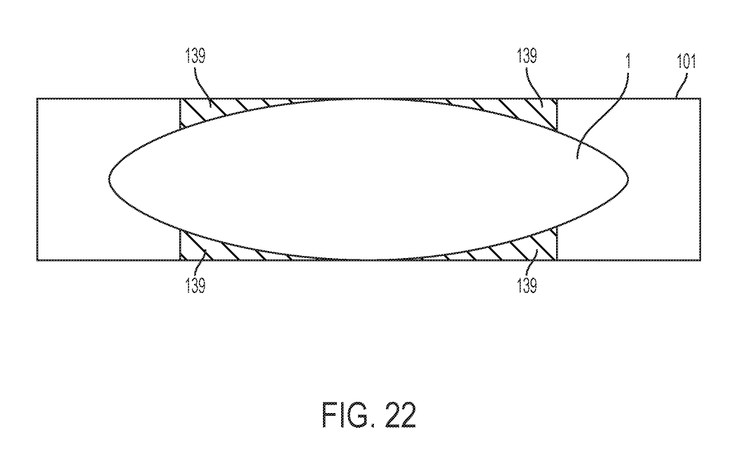

For use in packaging surfboard 1 or a similar object, packaging 100 may include at least two types of frames, surface frames and edge frames. Surface frames typically abut or are contoured to fit larger, more planar, surfaces of an object to be packaged, such as the top or bottom surfaces of surfboard 1. Edge frames typically abut or are contoured to fit thinner surfaces or the edges of an object to be packaged, such as the rails, nose, or tail of surfboard 1. In some embodiments, edge frames may be “U”-shaped edge frames 131 with an interior contour shaped as a “U” and therefore be configured to hug (directly or indirectly) or otherwise surround adjacent larger surfaces of the object in addition to interfacing with an edge of the object. In other embodiments, edge frames may be wedge frames 139, configured to abut only the edge surfaces of the object, for example, the rails of surfboard 1, as shown in FIG. 22.

The infrastructure of packaging 100 may also include braces, such as one or more lengthwise braces 141 and one or more widthwise braces 145, to support the objects. In certain example embodiments, lengthwise braces 141 are parallel with the longitudinal axis of surfboard 1 or another object, and widthwise braces 145 are parallel with its “short” axis. One or more of the braces may be cushioned with molded pulp, polyurethane foam, or another suitable material. Lengthwise braces 141 may be substantially orthogonal to widthwise braces 145. The braces may be made of cardboard, plastic (such as recycled plastic and/or substantially hollow plastic), or another suitable material.

The infrastructure may also include bracket inserts to directly or indirectly hold and protect the object being packaged and/or to stabilize the infrastructure within the outer enclosure 101. The bracket inserts may be sized and shaped to support and protect surfboards 1, for example, by being configured to abut or secure one or more edge frames. The bracket inserts may be, for example, substantially “U”-shaped or substantially “L”-shaped.

The frames, braces, and/or bracket inserts may also have slots or slits at or near the edges that allow the frames, braces, and/or bracket inserts to be orthogonally intersected, joined, and/or affixed through the slots or slits, such as without adhesives. For example, the bracket inserts may be adapted such that two different sets of bracket inserts (e.g., horizontal bracket insert 191 and vertical bracket insert 192) can intersect, such as at a perpendicular angle, and such as to allow both sets of bracket inserts to maintain structural support against the outer enclosure while intersecting.

The infrastructure may further include stabilizers 180 to secure the position of frames within outer enclosure 101 and relative to the rest of the packaging 100. For example, stabilizers 180 may be shaped as substantially rectangular prisms and affixed to outer enclosure 101 adjacent to and/or abutting opposite sides of individual frames. The stabilizers may be made of cardboard, lightweight wood, plastic, or any suitable material, and may be shaped as, for example, short or elongated blocks. Stabilizers 180 may be attached to packaging 100 by any suitable means, such as for example, by adhesive, Velcro, or another suitable means to outer enclosure 101 or the bracket inserts.

The infrastructure may additionally include one or more cushions to abut, surround, and/or otherwise protect surfboard 1 or other object(s) to be packaged. The cushions may be made of sponge, rubber, bubble wrap, foam, or other suitable materials for absorbing impacts to protect the packaged object(s), and may be used for adjusting, fitting, stabilizing, and/or fastening object(s) of different shapes and sizes. The sizes and thicknesses of the cushions may be preselected to fill gaps in the packaging, such as gaps that are left between one or more of the braces, frames, and outer enclosure. For example, cushions may have shapes that are substantially cylindrical, tubular, or substantially wedge-shaped. In another example, cushions may be placed abutting the nose and/or tail of a surfboard or along the rail of surfboard 1. The cushions may be made of or filled with high resilience foam or similar padding, and, along with other supporting materials in the infrastructure, the cushions may enable comfortable fastening of the object(s) of different sizes and shapes within the packaging, such as, for example, substantially cube-shaped objects or objects with differently shaped protrusions such as arms. One or more of the cushions may be inflatable (such as composed of one or more inflatable bladders), such as made of an inflatable rigid foam, inflatable padding, or other suitable inflatable material, to provide frictional fitting and fastening for the protection of the object(s) inside the packaging system.

In some embodiments, the inner curvature of a frame (such as the “U”-shaped inner surface) has one or more abutting cushions adhered thereto (such as with glue or another an adhesive material) to hold the packaged object(s) through frictional contact with the cushions. In another embodiment, cushions are adhered to the packaged object(s) by an adhesive that allows the cushions to later be easily and cleanly removed. In yet other embodiments, cushions are provided inside outer enclosure 101 to package the object(s) without one or both of braces and the frames.

Cushions may be provided between outer enclosure 101 and parts of the infrastructure, such as the bracket inserts or the frames. In another example, cushions may be provided between different layers of bracket inserts (e.g., between distinct nested bracket inserts). In still another example, one or more cushions may be provided between different layers of the outer enclosure (e.g., between distinct nested cardboard boxes) to provide protection and shock absorption for the inner layer of outer enclosure 101.

Moreover, the infrastructure may comprise internal fastening straps 170 to fasten surfboard 1 or another object(s) to or in between the frames or otherwise secure surfboard 1 or the other object(s) within packaging 100. Fastening straps 170 may be substantially flexible straps, strings, or wires that have sufficiently high tensile strength to hold the object(s) against the abutting frames (or cushions) for support. Optionally, fastening straps 170 may be substantially flat to distribute pressure substantially evenly across the abutting surface of the physical object. Fastening straps 170 may be made of plastic (such as recycled plastic), fabric (such as stretch fabric or cotton), fiber, rope, elastic material (such as rubber or latex), and/or other suitable materials.

Finally, the infrastructure may include additional protections for the packaged object(s), such as wrapping material, reinforcement boards 151, or rigid shaped elements 155. Wrapping material, such as, for example, bubble wrap, saran wrap, or similar materials, may be wrapped around the packaged object(s) or parts thereof for protection and for adjusting and fitting object(s) of different sizes. For example, the wrapping materials may be used where the object(s) touch the frames for frictional adjustment and protection of the object(s). In some embodiments, the infrastructure may include one or more reinforcement boards 151 to structurally reinforce against bending and/or twisting. Reinforcement boards 151 preferably comprise plastic or cardboard in a honeycomb configuration, but may additionally or alternatively comprise the materials and configurations described herein with respect other components of packaging 100. Rigid shaped elements 155 may provide additional protection to selected portions of the packaged object(s), for example the nose and/or tail of a surfboard 1, against impacts or excessive external pressures. Rigid shaped elements 155 may be contoured to the selected portions of the packaged object(s) for which additional protection is sought.

Various components of packaging 100, such as outer enclosure 101 (with or without the infrastructure), may be assembled around the object(s) to create a packaging for protection. Alternatively, outer enclosure 101 and the infrastructure of packaging 100 may be preassembled to receive an object(s) to be packaged (e.g., a surfboard 1) that is slid into the enclosure from the open top. Then, additional materials (such as the cushions) of the infrastructure are inserted on top of the inserted object(s) and in frictional contact with outer enclosure 101 or other parts of the packaging to create one or more protective layers around the object(s).

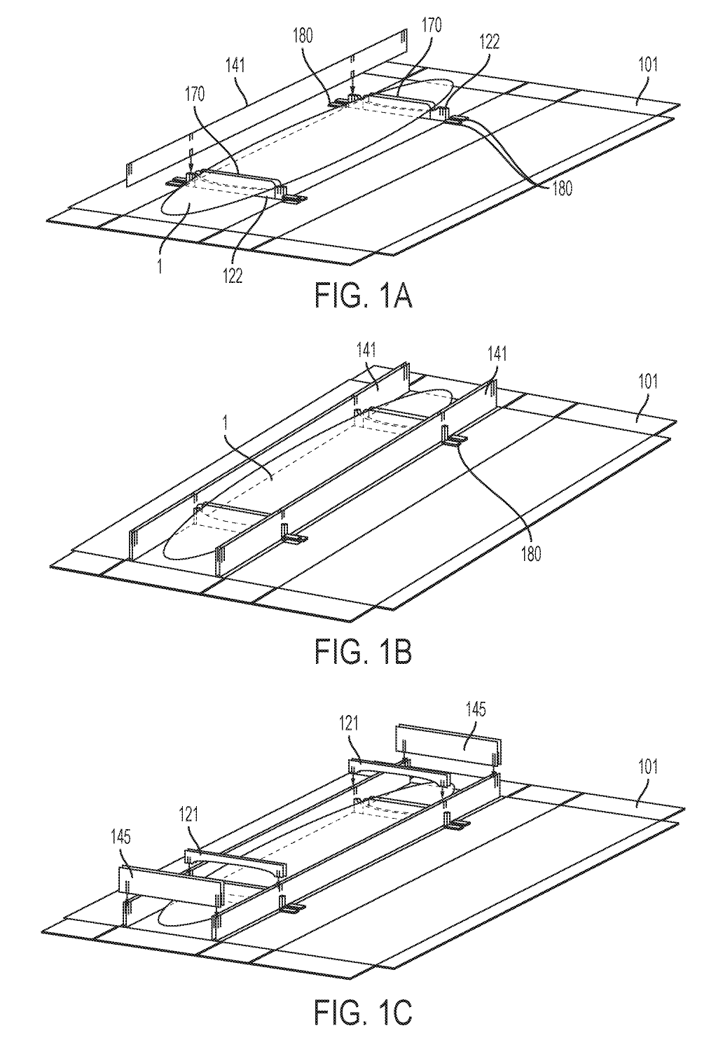

FIGS. 1A-1C depict an illustrative example of surfboard packaging and sequential steps of a method of assembling the surfboard packaging 100 around the surfboard 1. In this embodiment, two pairs of lengthwise braces 141 are provided at opposite sides of the packaging, and two pairs of widthwise braces 145 are provided perpendicular to the lengthwise braces and at opposite sides of the packaging. One pair of bottom contoured frames 122, two pairs of top contoured frames 121, and four pairs of stabilizers 180 are also provided. Lengthwise braces 141, widthwise braces 145, and frames 121, 122 have slots to permit affixing these parts to each other at perpendicular joints. Fastening straps 170 are also depicted. A cardboard box that forms outer enclosure 101 is shown in an opened state.

Consistent with FIGS. 1A-1C, packaging 100 may be assembled in one example as follows. First, slits of the pairs of lengthwise braces 141 are engaged with slits of the pair of bottom contoured frames 122, and the resulting structure is set in position on opened outer enclosure 101. Second, surfboard 1 is placed on the pair of bottom contoured frames 122 and tied down with fastening straps 170. The fastening straps may be secured to the pair of bottom contoured frames 122 and/or outer enclosure 101. Third, eight stabilizers 180 are glued or otherwise fastened to opened outer enclosure 101 as to support the edges of the pair of bottom contoured frames 122 after outer enclosure 101 is folded. Fourth, slits of the pairs of top contoured frames 121 are engaged with slits of the pairs of lengthwise braces 141. Fifth, slits of the pairs of widthwise braces 145 are engaged with slits of the pairs of lengthwise braces 141. Sixth, outer enclosure 101 is folded around the assembled infrastructure.

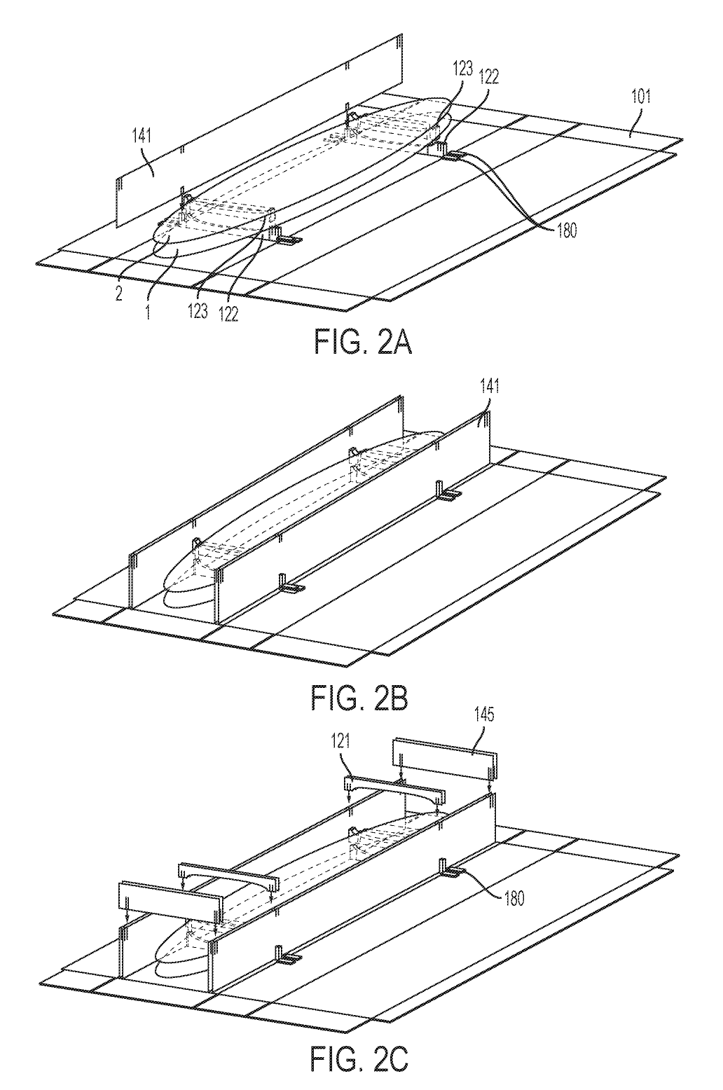

FIGS. 2A-2C depict an illustrative example of packaging 100 for two surfboards 1, 2 and sequential steps of a method of assembling it. This embodiment is substantially similar to that of FIGS. 1A-1C, however, a pair of middle contoured frames 123 may be provided in this embodiment, in addition to the pairs of top contoured frames 121 and bottom countered frames 122. Middle contoured frames 123 may be placed on top of first surfboard 1, such that it is sandwiched between first surfboard 1 and second surfboard 2.

Consistent with FIGS. 2A-2C, packaging 100 may be assembled in one example as follows. First, slits of the pairs of lengthwise braces 141 are engaged with slits of the pair of bottom contoured frames 122, and the resulting structure is set in position on the opened outer enclosure 101. Second, a first surfboard 1 is placed on the pair of bottom contoured frames 122; a pair of middle contoured frames 123 are placed on the surfboard; and a second surfboard 2 is placed on top of the pair of middle contoured frames 123. Both surfboards 1, 2 and both sets of contoured frames 122, 123 are tied down with fastening straps 170. The fastening straps may be secured to the pair of bottom contoured frames 122 and/or outer enclosure 101. Third, eight stabilizers 180 are glued or otherwise fastened to the opened outer enclosure 101 as to support the edges of the pair of bottom contoured frames 122 after outer enclosure 101 is folded. Fourth, slits of the pairs of top contoured frames 121 are engaged with slits of the pairs of lengthwise braces 141. Fifth, slits of the pairs of widthwise braces 145 are engaged with slits of the pairs of lengthwise braces 141. Sixth, outer enclosure 101 is folded around the assembled infrastructure.

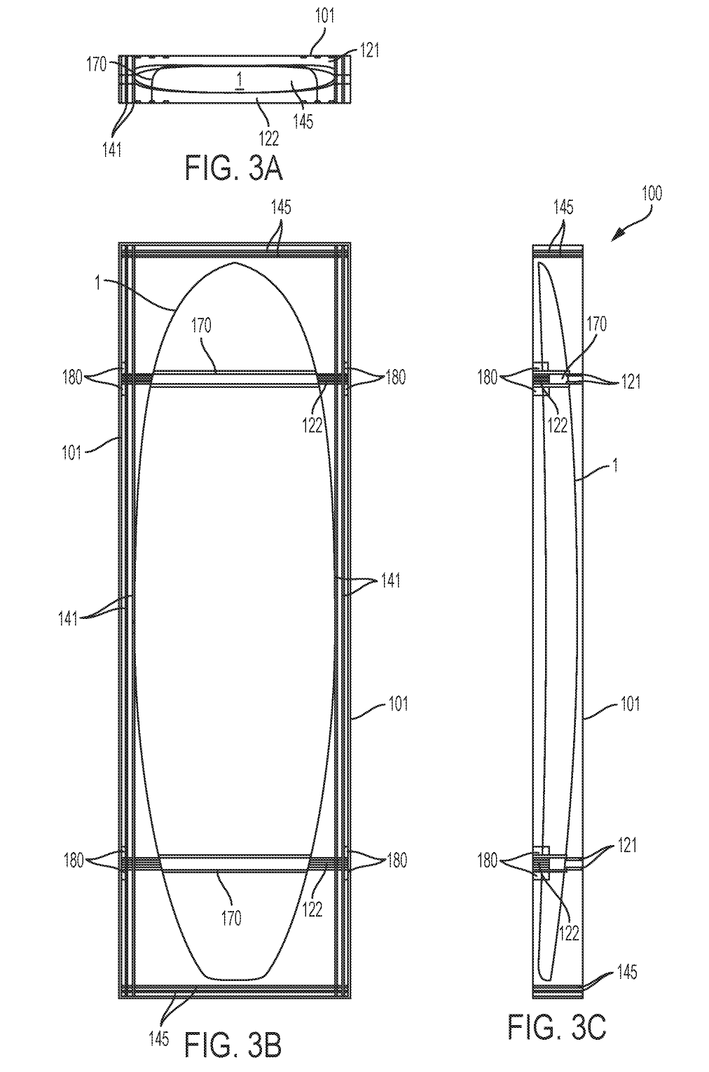

FIGS. 3A-3C depict cross-sectional front, top, and side views, respectively, of an illustrative example of packaging 100 for a single surfboard 1, and which is consistent with the embodiment depicted in FIGS. 1A-1C. In this embodiment, a pair of lengthwise braces 141 are provided at each opposite side of the packaging 100, and two pairs of widthwise braces 145 are provided perpendicular to the lengthwise braces and at opposite sides of the packaging. Bottom contoured frames 122, top contoured frames 121 and fastening straps 170, and stabilizers 180 are also depicted. As shown, bottom contoured frames 122 may protrude through the outer set of lengthwise braces 141 and stabilizers 180 may secure bottom contoured frames 122 outside of the outer set of lengthwise braces 141. In one example embodiment, the packaging 100 may have dimensions of about 126″×36″×8″.

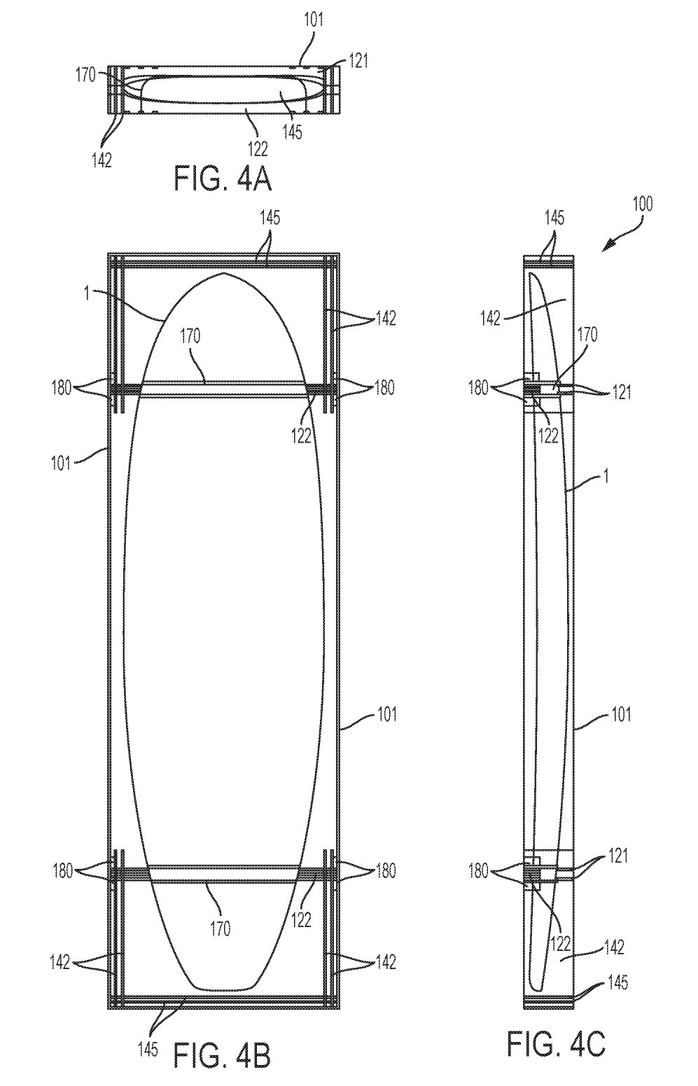

FIGS. 4A-4C depict cross-sectional front, top, and side views, respectively of an alternative embodiment of packaging 100 for a single surfboard 1. While this embodiment is similar to that of FIGS. 3A-3C, it features separated lengthwise braces 142, which do not run the full length of the packaging 100, in lieu of full length lengthwise braces 141. As best viewed in FIGS. 4B and 4C, two pairs of separated lengthwise braces 142 may be engaged with both widthwise braces 141, a bottom contoured frames 122, and top contoured frames 121 at each of the nose end and tail end of surfboard 1.

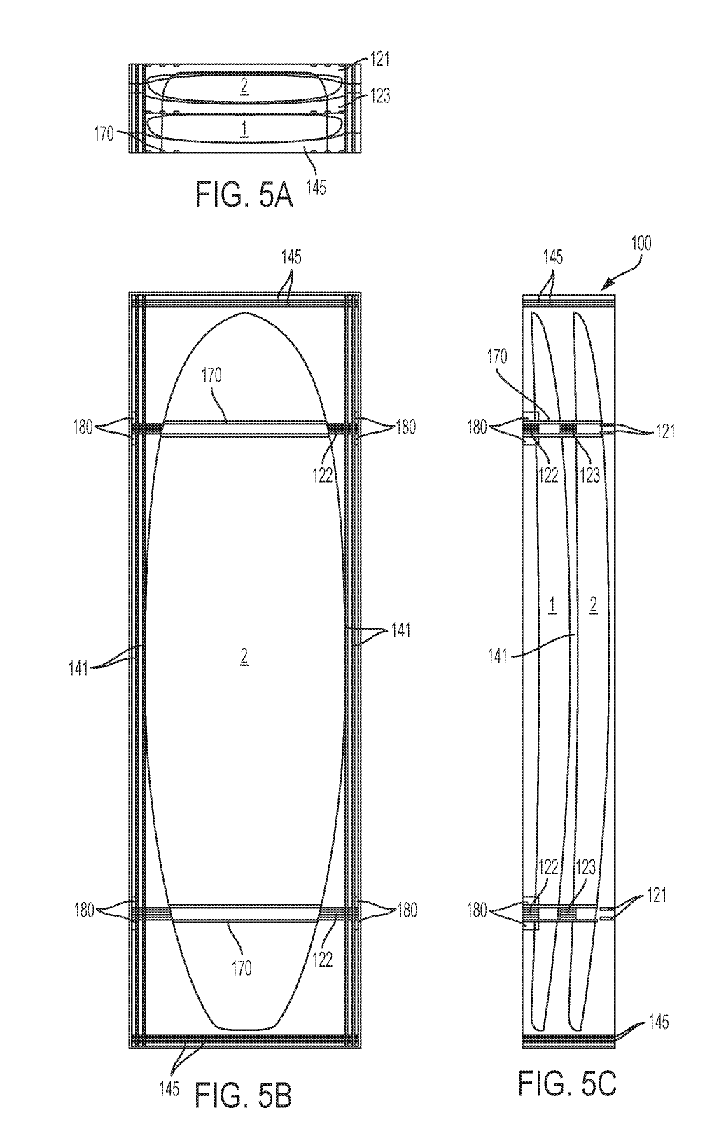

FIGS. 5A-5C depict cross-sectional front, top, and side views, respectively, of an illustrative example of packaging 100 for a first surfboard 1 and second surfboard 2, which is consistent with the embodiment depicted in FIGS. 2A-2C. In one example embodiment, the packaging 100 may have dimensions of about 126″×36″×15″. FIGS. 5A-5C are similar to FIGS. 3A-3C; however, a pair of middle contoured frames 123 may be provided in this embodiment, in addition to the pairs of top contoured frames 121 and bottom countered frames 122. The middle contoured frames 123 may be placed on top of first surfboard 1, such that it is sandwiched between the first surfboard 1 and second surfboard 2.

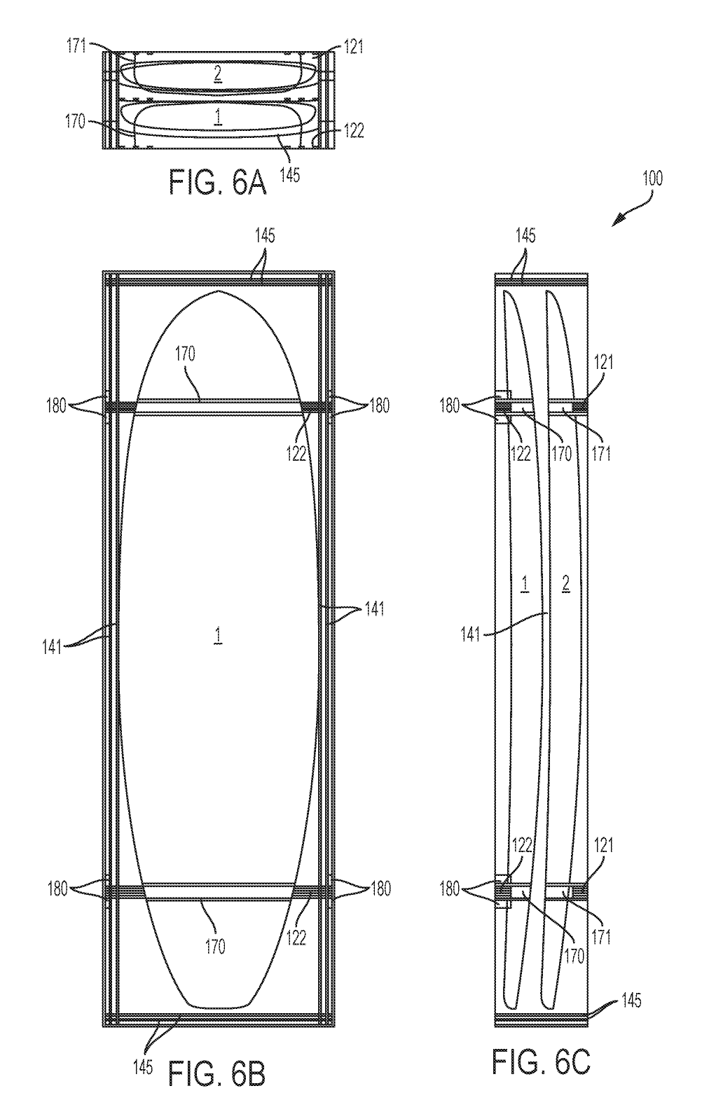

FIGS. 6A-6C depict cross-sectional front, top, and side views, respectively, of an embodiment of packaging 100 for first surfboard 1 and second surfboard 2. While similar to that depicted in FIGS. 5A-5C, in this example, the middle contoured frames 123 are not provided to accommodate second surfboard 2 and may be omitted. In their place, two sets of fastening straps 170 and 171 may pull the two surfboards in opposite directions to keep them from knocking against each other. In such embodiments, a single, but thicker, top contoured frame 121 be used to support each of the note and tail sections of second surfboard 2.

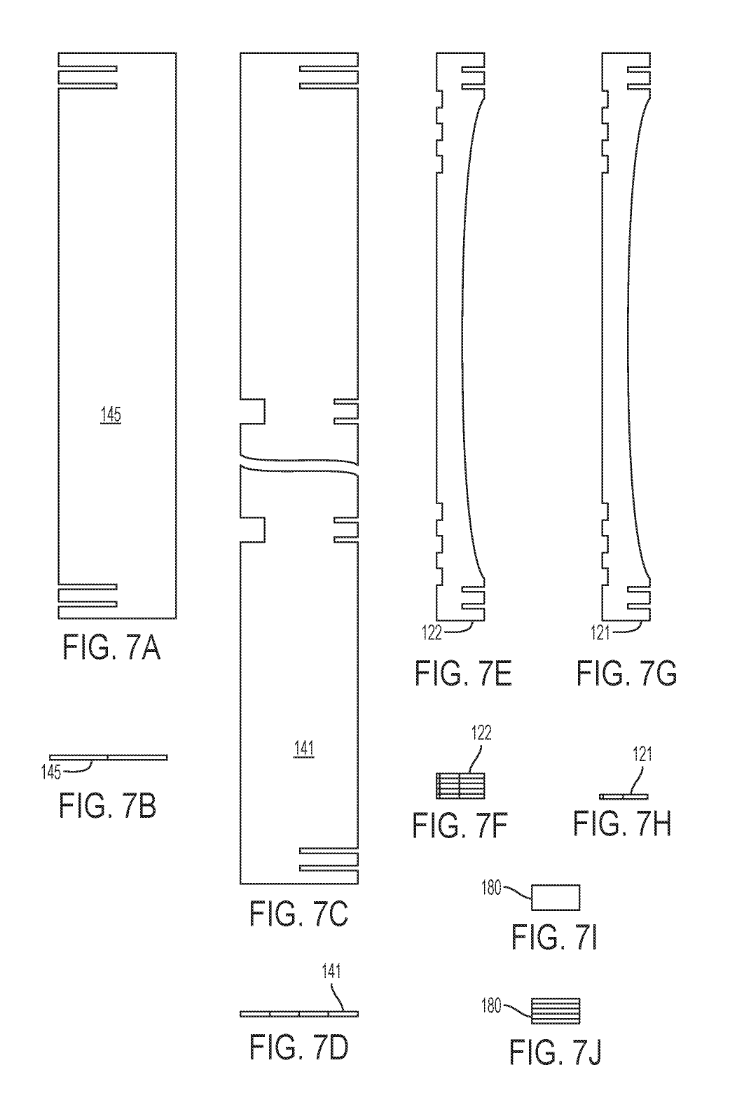

FIGS. 7A-7J illustrate exemplary details of selected infrastructure components consistent with the embodiment(s) depicted in FIGS. 1A-1C and FIGS. 3A-3C. FIGS. 7A and 7B are respective front and side views of a widthwise brace 145. FIGS. 7C and 7D are respective front and side views of a lengthwise brace 141. FIGS. 7E and 7F are respective front and side views of a bottom contoured frame 122, which is some embodiments comprises five glued cardboard layers. FIGS. 7G and 7H are respective front and side views of a top contoured frame 121. FIGS. 7I and 7J are respective front and side views of a stabilizer 180, which in some embodiments may comprise five glued cardboard layers. Particular examples of dimensions, ratios, layerings, notch configurations, and the like are illustrated in FIGS. 7A-7J, but are not limiting.

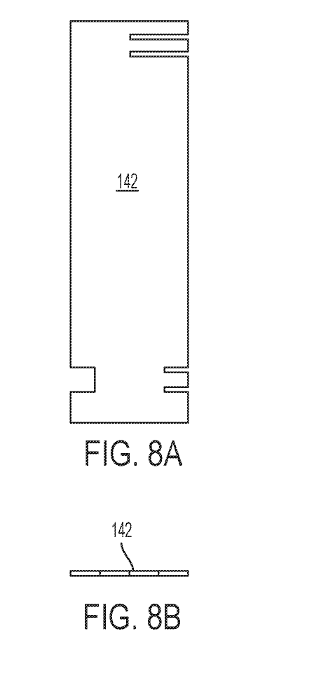

FIGS. 8A and 8B illustrate respective front and side views of a separated lengthwise brace 142 consistent with the embodiment(s) depicted in FIGS. 4A-4C. Particular examples of dimensions, ratios, layerings, notch configurations, and the like are illustrated in FIGS. 8A-8B, but are not limiting.

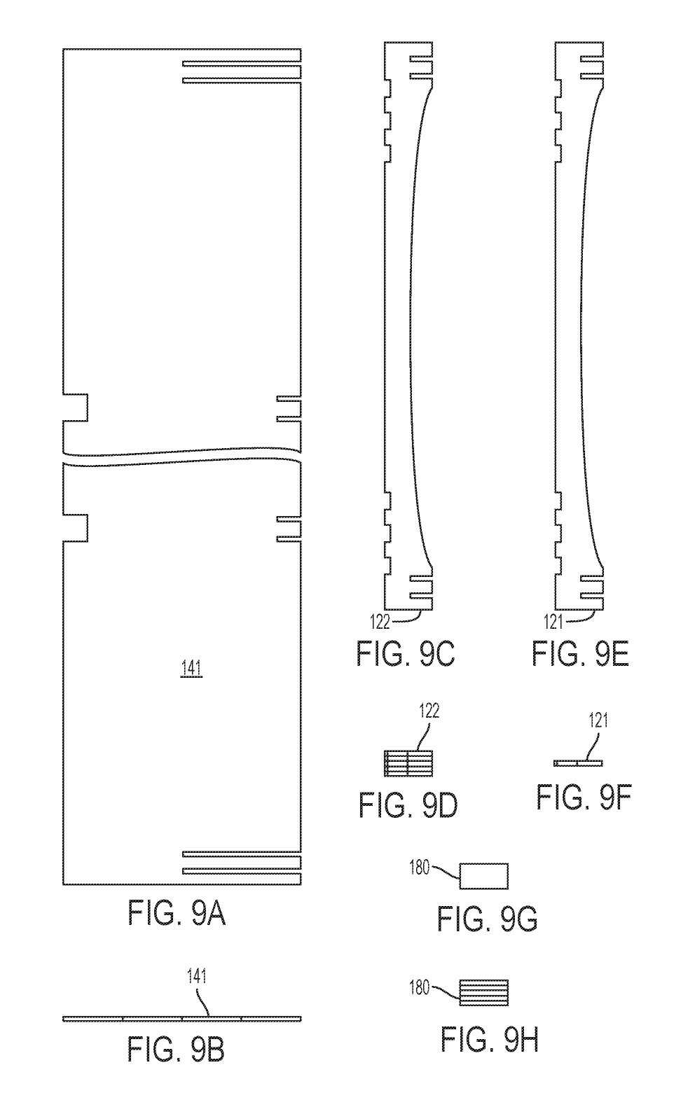

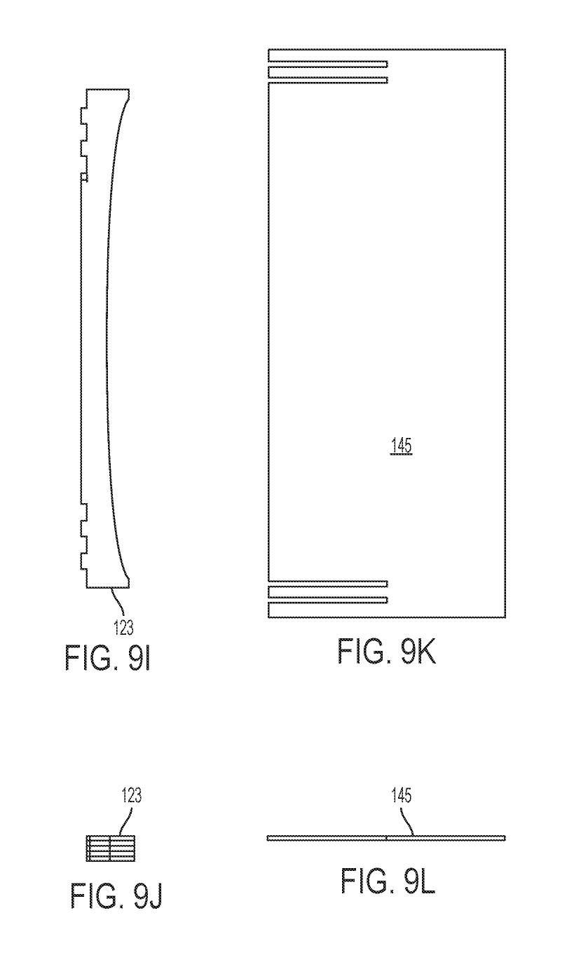

FIGS. 9A-9L illustrate exemplary detail of selected infrastructure components consistent with the embodiment(s) depicted in FIGS. 2A-2C and FIGS. 5A-5C. FIGS. 9A and 9B are respective front and side views of a lengthwise brace 141. FIGS. 9C and 9D are respective front and side views of a bottom contoured frame 122, which is some embodiments comprises five glued cardboard layers. FIGS. 9E and 9F are respective front and side views of a top contoured frame 121. FIGS. 9G and 9H are respective front and side views of a stabilizer 180, which is some embodiments comprises five glued cardboard layers. FIGS. 9I and 9J are respective front and side views of a middle contoured frame 123, which is some embodiments comprises five glued cardboard layers. FIGS. 9K and 9L are respective front and side views of a widthwise brace 145. Particular examples of dimensions, ratios, layerings, notch configurations, and the like are illustrated in FIGS. 9A-9L, but are not limiting.

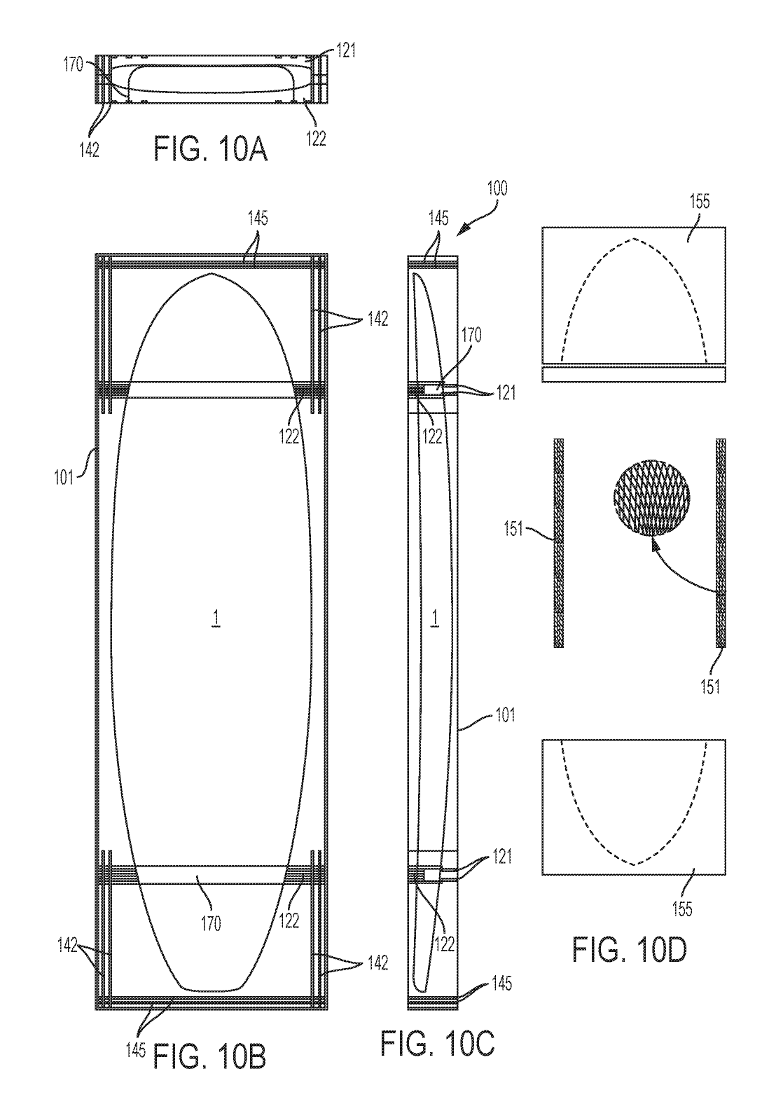

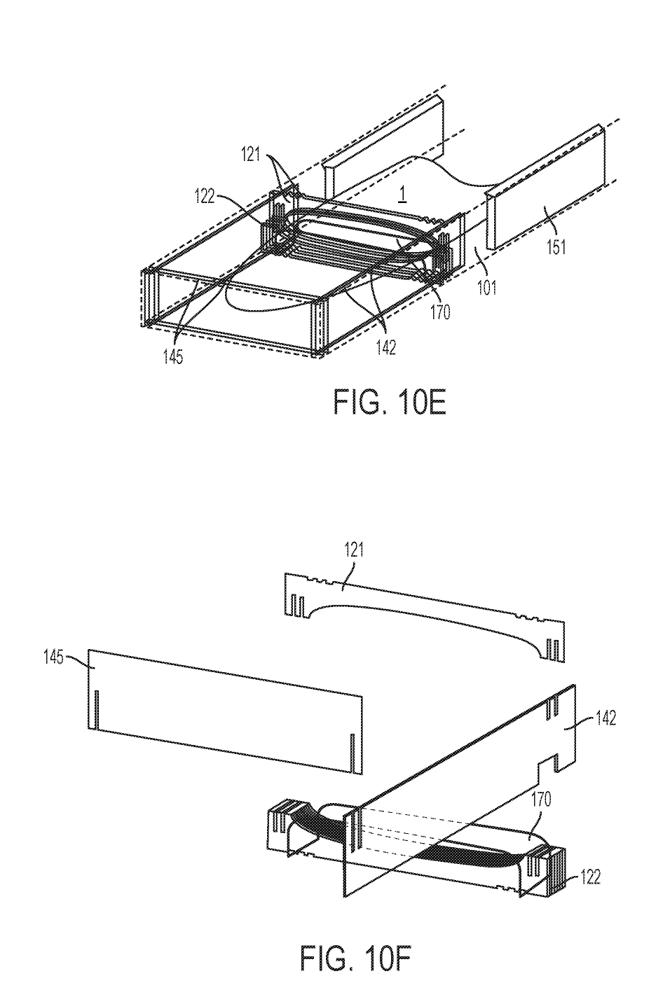

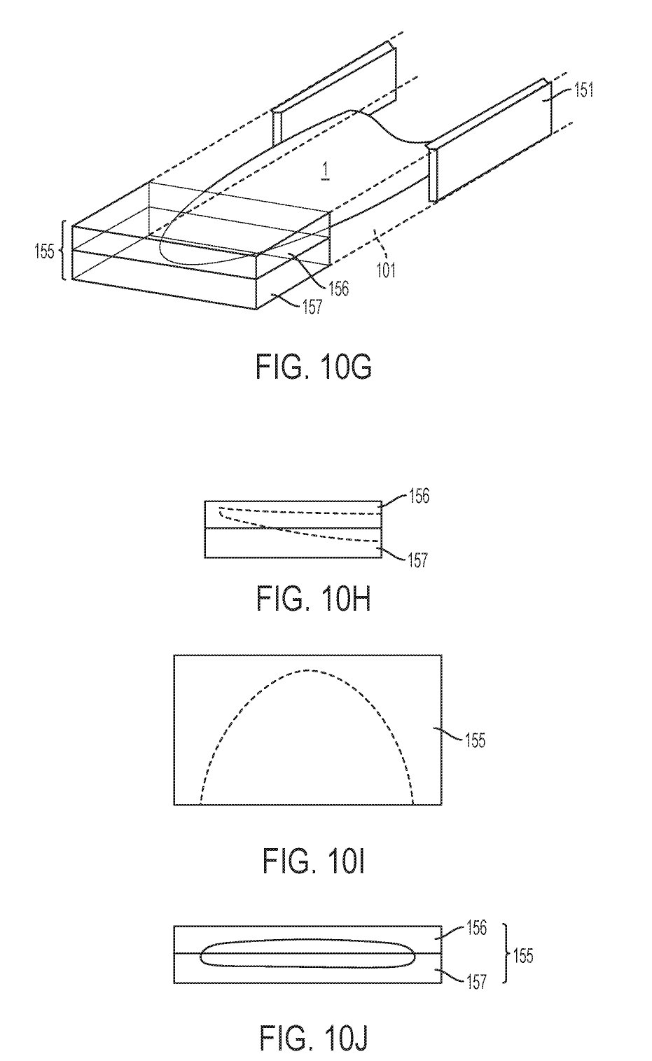

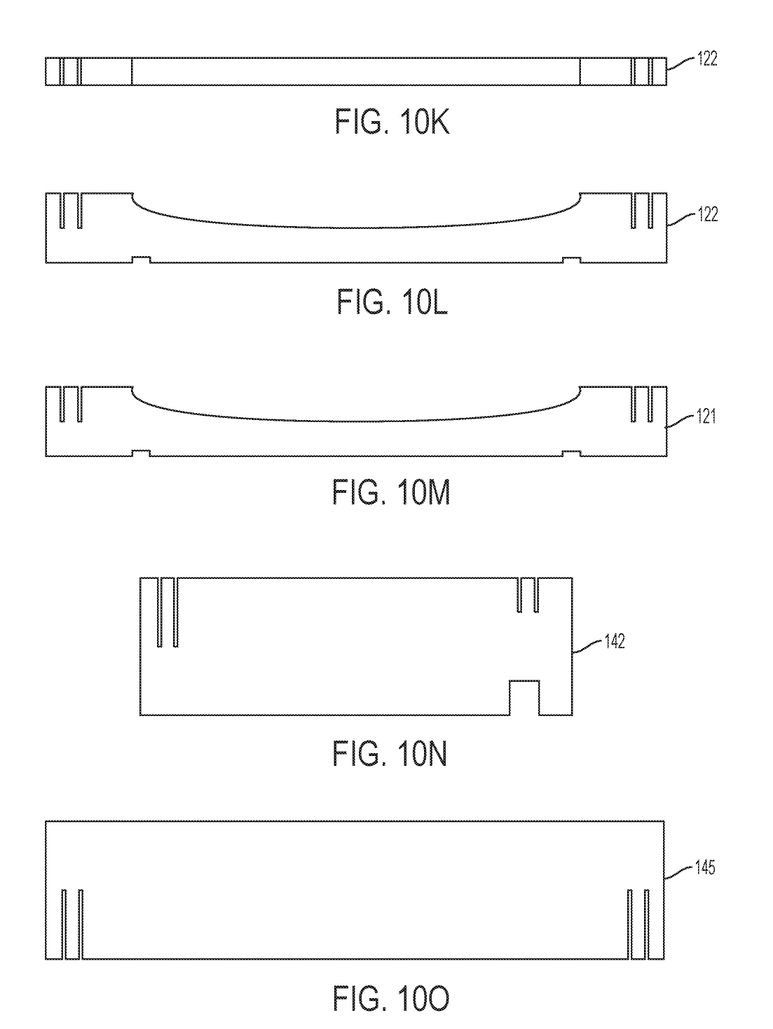

FIGS. 10A-10O illustrate an embodiment of surfboard packaging 100 that is useful for shipping a single board 1. Here, similar to the embodiment depicted in FIGS. 4A-C, the lengthwise braces 141 may be composed of two distinct sets of separated lengthwise braces 142 at the lengthwise ends of the packaging, separated by a gap. Bottom contoured frame 122 may preferably be comprised of molded pulp. In further alternative embodiments, top contoured frames 121 may be omitted and surfboard 1 secured to the bottom contoured frame 122 only with fastening straps 170. As shown in FIG. 10D, lengthwise reinforcement boards 151 may be provided in the mid-section of the packaging 100 to structurally reinforce the lengthwise middle of packaging 100 against bending, twisting, and/or impacts or excessive external pressure. In addition, rigid shaped elements 155 may be provided to serve as nose and tail protectors. They may abut the nose and tail of the surfboard 1 to protect these parts against impacts, and may also serve to further secure the surfboard in the packaging 100. For example, the nose and tail protectors may be made of rigid foam that partially or wholly encloses the nose and tail of the surfboard.

FIG. 10E illustrates a three dimensional interior view of packaging comprising the components of FIGS. 10A-D, except for the rigid shaped elements 155. FIG. 10F illustrates exemplary engagement mechanisms between bottom contoured frame 122 and separated lengthwise brace 142, between separated lengthwise brace 142 and top contoured frame 121, and between separated lengthwise brace 142 and widthwise brace 145.

Consistent with FIGS. 10A-10C, 10E, and 10F, an exemplary method of assembling the infrastructure for a nose or tail section of the packaging 100 may comprise the following steps (though the order may be altered): First, lower contoured frame 122 is provided, for example by being formed out of molded pulp or by gluing or otherwise affixing a number of layers (e.g., 10) of cardboard or plastic together. Second, slits of the four separated lengthwise braces 142 are engaged with slits of the lower contoured frame 122. Third, slits of the two widthwise braces 145 are engaged with slits of the four separated lengthwise braces 142. Fourth, a surfboard 1 is placed on the bottom contoured frame 122, making sure that there are approximately two inches of space or more between the top of the nose or tail of surfboard 1 and the closest widthwise brace 145. Fifth, the surfboard is tied down to the lower contoured frame 122 with fastening straps 170. Sixth, slits of two top contoured frames 121 are engaged with slits of the pairs of separated lengthwise braces 142. Additionally, surfboard 1 may be protected with a wrapper at least where it contacts the frames.

FIG. 10G illustrates an exemplary positioning of rigid shaped element 155, with respect to the nose or tail of a surfboard 1. FIGS. 10H-10K depict cross-sectional side, top, and front views, respectively, of an embodiment of rigid shaped element 155. The rigid shaped element 155 may include two components, which may be preferably comprised of foam: An upper slab 156 may be positioned on the top side of surfboard 1 and a lower slab 157 may be positioned on the bottom side of surfboard 1. Each slab may be made by injection molding and includes empty space to fit the nose or tail of surfboard 1 (or the front or back ends of another object). The space can be made to accommodate most types of surfboards 1, but may be too large for some surfboards or other objects. In the latter case, bubble wrap material or the like can be used to fill the excess space. The thickness of upper slab 156 plus thickness of lower slab 157 may approximate the interior height of outer enclosure 101. Rigid shaped element 155 may serve to secure the surfboard by further prevent it from becoming loose during shipping. In practice, the length of an outer enclosure 101 may be selected for different lengths of a surfboard 1 (or other object) or a fixed length may be used. The upper and lower slabs 156, 157 may be taped or otherwise affixed together prior to placement in outer enclosure 101. In one example, the surfaces of the surfboard 1 or other packaged object may be kept at least one inch away from all internal walls of the outer enclosure 101, to afford additional protection from impacts or the like during shipping.

FIGS. 10K-10O illustrate exemplary detail of selected infrastructure components consistent with the embodiment(s) depicted in FIGS. 10A-10C and 10E-10F. FIGS. 10K and 10L are respective top and front views of a bottom contoured frame 122, which in some embodiments comprises either molded pulp or multiple layers of cardboard or plastic. FIG. 10M is a front view of a top contoured frame 121. FIG. 10N is a front view of a separated lengthwise brace 142. FIG. 10O is a front view of a widthwise brace 145.

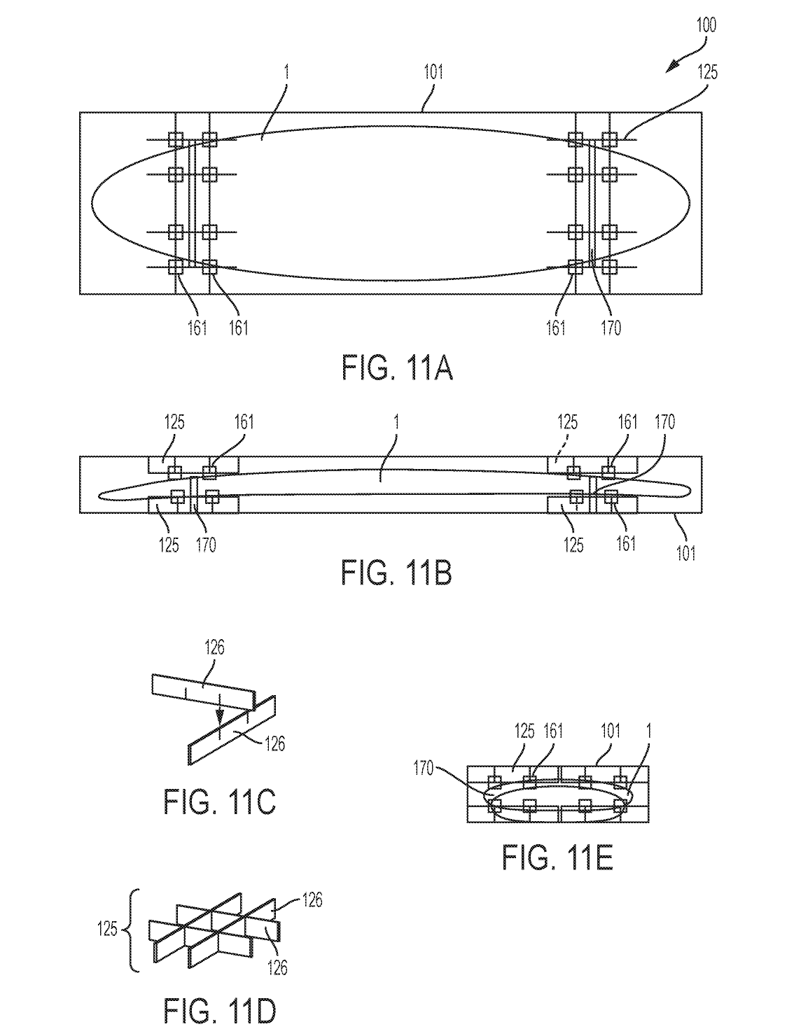

FIGS. 11A-11D illustrate an embodiment of packaging 100 where surfboard 1 or other physical object is expected to be stored or transported in a horizontal orientation. FIGS. 11A, 11B, and 11E are respective top, side, and front views of packaging 100, wherein the top, side, and front surfaces, respectively, of outer enclosure 101 are omitted for the purpose of illustration. As shown in FIGS. 11A, 11B, and 11D, the object to be packaged, which is surfboard 1 in this example, is placed horizontally and secured between assembled grid frames 125 inside outer enclosure 101, which may be a cardboard box. Fastening straps 170 and cushions provide fastening and fitting for the surfboard. The cushions may be foam pad cushions 161 in this example. FIGS. 11C and 11D are perspective views illustrating how grid frame boards 126 can be engaged to each other though slits and without use of adhesives in order to form an assembled grid frame 125. FIG. 11C shows that two of the grid frame boards 126, which may be cardboard structures in this example, may be orthogonally fixed to each other through the slits. FIG. 11D shows the assembled grid frame 125 formed by two pairs of grid frame boards 126.

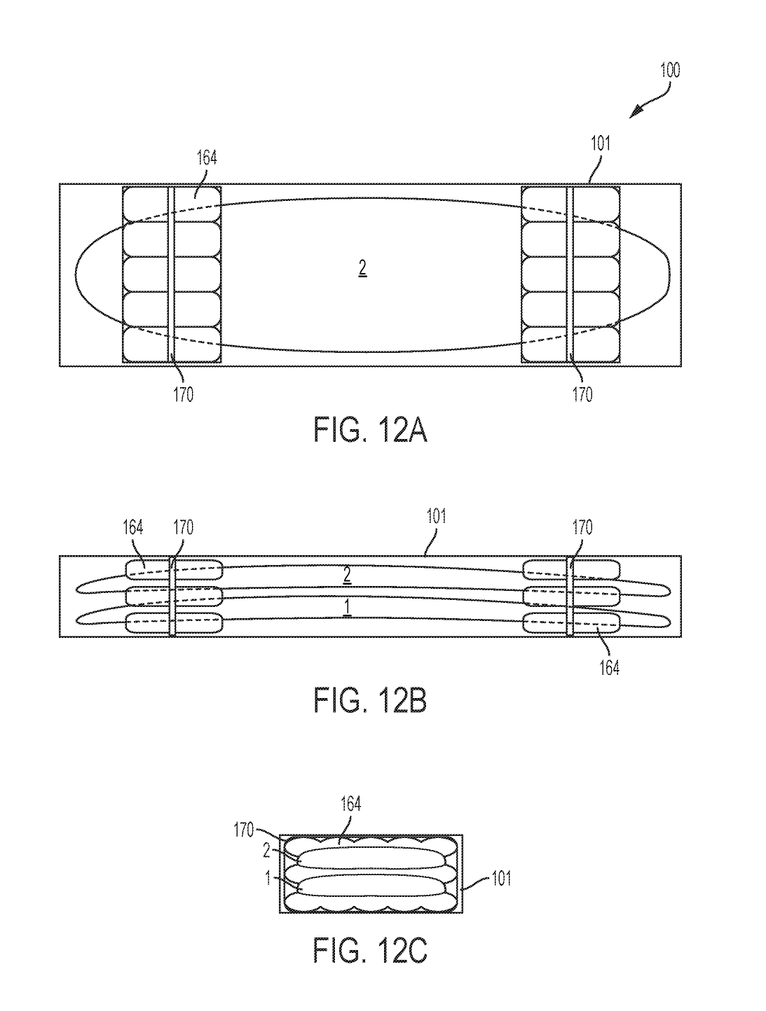

FIGS. 12A-12C illustrate an alternative embodiment of packaging 100 where multiple objects, for example first surfboard 1 and second surfboard 2, are expected to be stored or transported in a horizontal orientation. FIGS. 12A-12C are respective top, side, and front views of packaging 100, wherein the top, side, and front surfaces, respectively, of outer enclosure 101 are omitted for the purpose of illustration. As illustrated, first surfboard 1 and second surfboard 2 may be packaged and secured horizontally and on top of each other. Three pairs of cushions that are preferably short inflatable pads 164 may be placed near the front and back ends of the longitudinal axis on surfboards 1 and 2, with one pair below first surfboard 1, one pair in between the surfboards, and one pair on top of second surfboard 2. The inflatable pads 164 may be, for example, multiple elongated and parallel air bladders as shown. Two fastening straps 170 positioned in line with the inflatable pads 164 at the front and back ends, respectively, may be provided secure the inflatable pads 164 and surfboards 1 and 2 in a suitable configuration.

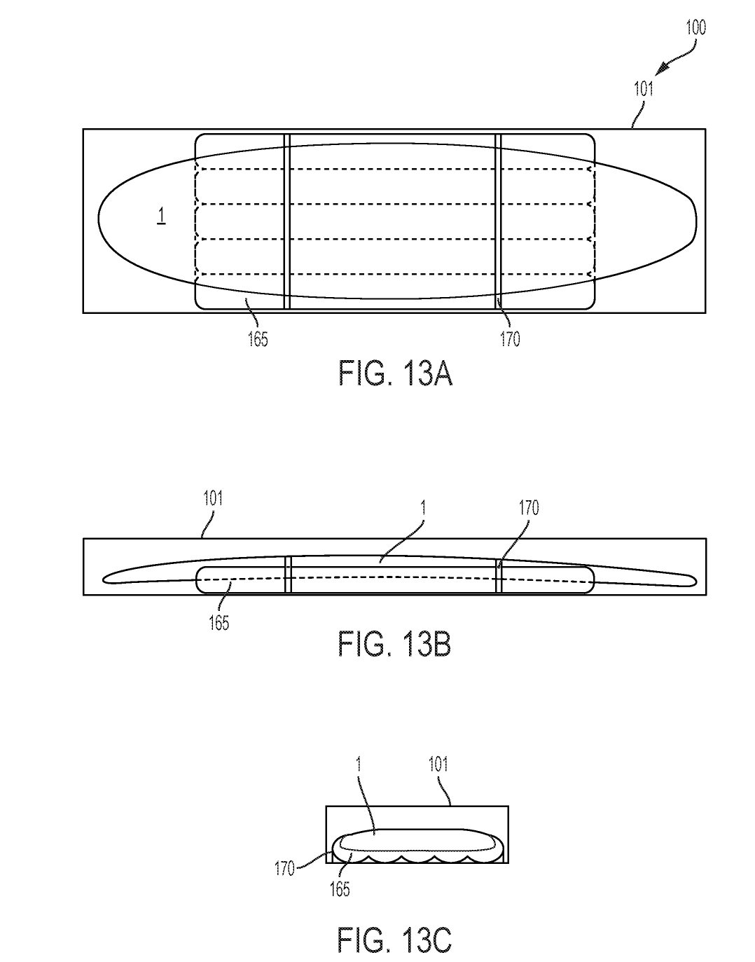

FIGS. 13A-13C illustrate an embodiment of horizontal packaging 100 where an object, for example surfboard 1, is packaged and secured horizontally with one or more cushions and a pair of fastening straps 170. FIGS. 13A-13C are respective top, side, and front views of packaging 100, wherein the top, side, and front surfaces, respectively, of outer enclosure 101 are omitted for the purpose of illustration. One cushion that is preferably an elongated inflatable pad 165 may be placed underneath surfboard 1. A pair of fastening straps 170 at the front and back ends, respectively, of surfboard 1 are provided to secure the elongated inflatable pad 165 against the surfboards 1 in a suitable configuration. Elongated inflatable pad 165 may comprise, for example, multiple elongated and parallel air bladders.

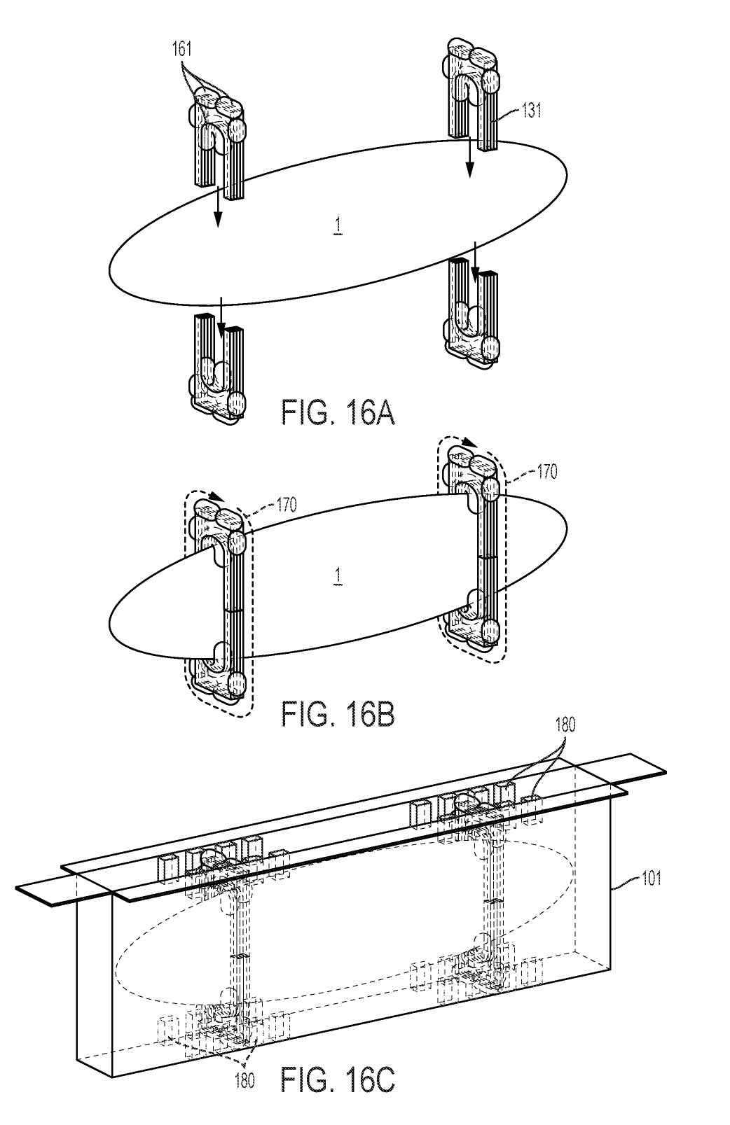

FIG. 16A-C illustrates an embodiment of surfboard packaging 100 that comprises “U”-shaped edge frames 131 and depicts steps of a method of assembling such surfboard packaging 100. First, as shown in FIG. 16A, the top rail of a surfboard 1 may be engaged with a pair of “U”-shaped edge frames 131 near the respective front and back ends of surfboard 1. Second, the bottom rail of surfboard 1 is engaged with a second pair of “U”-shaped edge frames 131 at a longitudinal position corresponding to the top frames 131. As illustrated, foam pad cushions 161 (or another type of cushion) may be positioned between the rails of the surfboard 1 and the inside curved sections of the “U”-shaped edge frames 131 (“inner surface”). As illustrated, foam pad cushions 161 may additionally be positioned on the outside edges and/or corners of the “U”-shaped edge frames 131 (e.g., away from where the frames 131 contact the rails). In some embodiments, foam pad cushions 161 may be affixed to “U”-shaped edge frames 131 with, for example, glue. Further, in some embodiments, foam pad cushions 161 may be omitted from the top rail. Third, as shown in FIG. 16B, a pair of fastening straps 170 are used to wind around the “U”-shaped edge frames 131 at the front and back ends to secure the “U”-shaped edge frames 131 and surfboard 1 respectively.

Fourth, as shown in FIG. 16C, multiple stabilizers 180 may be affixed, for example with glue, to the inside of the outer enclosure 101 for receiving the “U”-shaped edge frames 131 at the front and back ends respectively. Typically, four stabilizers 180 are used to secure each “U”-shaped edge frame 131. As illustrated, eight stabilizers 180 are provided for each “U”-shaped edge frame 131, which allows for multiple frame 131 positions and therefore an adjustable mounting position to accommodate differently dimensioned surfboards while using a standardized outer enclosure 101. In other embodiments, stabilizers 180 may be mountable via Velcro tape or a similar mechanism to provide additional adjustability. Fifth, surfboard 1—as secured with the “U”-shaped edge frames 131, foam pad cushions 161, and fastening straps 170—is slid into the outer enclosure 101 between the stabilizers 180. Sixth, the outer enclosure 101 may be sealed. For example, the top flaps of the outer enclosure 101 are closed—such as, for example, by large wire box staples or adhesive tape. The packaging 100 is ready for shipping.

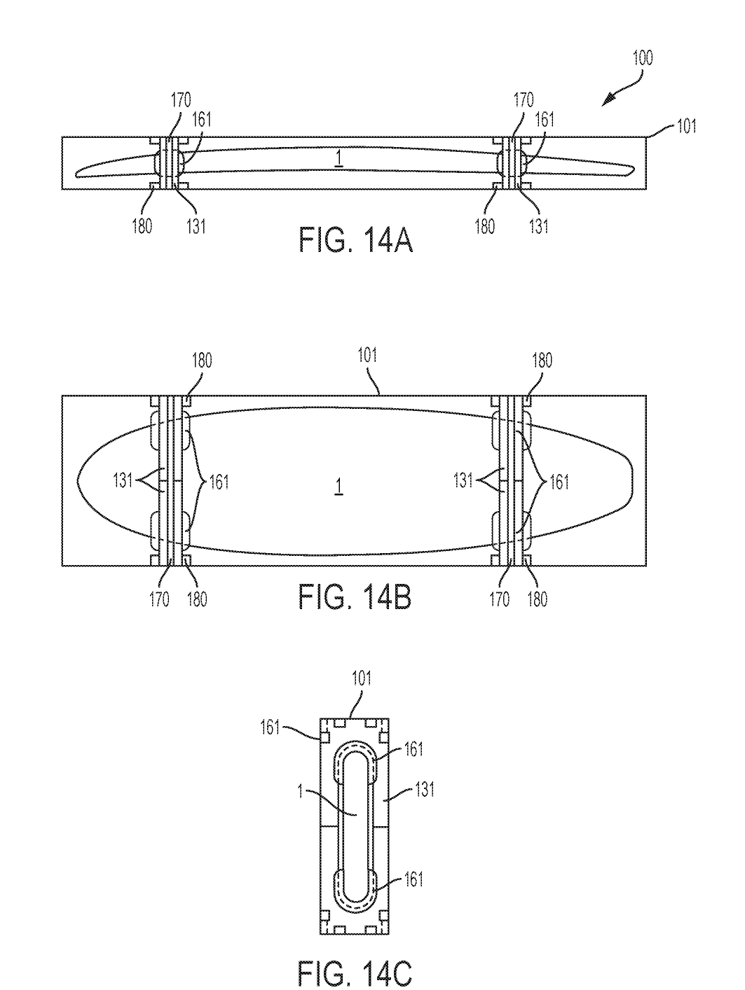

Consistent with the embodiment described with respect to FIG. 16A-16C, FIGS. 14A-14C illustrate an embodiment of packaging 100 where a surfboard 1 or other physical object is expected to be stored or transported in a vertical orientation. FIGS. 14A-14C are respective top, side, and front views of packaging 100, wherein the top, side, and front surfaces, respectively, of outer enclosure 101 are omitted for the purpose of illustration. In this embodiment, the infrastructure may include two pairs of “U”-shaped edge frames 131, foam pad cushions 161 (or another type of cushions), stabilizers 180, and a pair of fastening straps 170. As illustrated, surfboard 1 may be packaged and secured vertically in the packaging 100 by two pairs of “U”-shaped edge frames 131, with foam pad cushions 161 placed between each frame 131 and the rails of surfboard 1. Each corresponding top and bottom pair of “U”-shaped edge frames 131 may be secured together with fastening straps 170, and may be secured in the outer enclosure 101 with stabilizers 180 at the front and back ends, respectively. In some embodiments, additional foam pad cushions 161 may be positioned between each “U”-shaped edge frame 131 and the outer enclosure 101 at the external bottom (i.e., across from the bottom of the inner surface) and/or at the external sides (i.e., across from the sides of the inner surface) of the frame 131. Glue or other fastening methods known in the art may be used to further secure various components together.

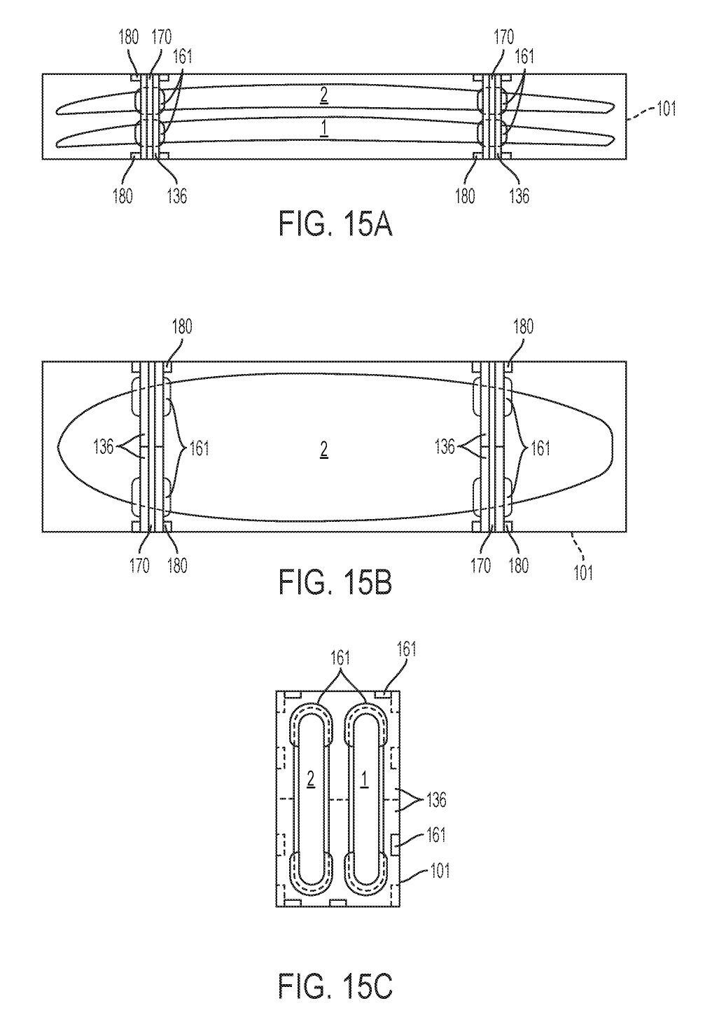

FIGS. 15A-15C illustrate an embodiment of packaging 100 where multiple objects, for example first surfboard 1 and second surfboard 2, are expected to be stored or transported in a vertical orientation. FIGS. 15A-15C are respective top, side, and front views of packaging 100, wherein the top, side, and front surfaces, respectively, of outer enclosure 101 are omitted for the purpose of illustration. As illustrated, first surfboard 1 and second surfboard 2 may be packaged and secured parallel to one another. In contrast to the embodiment depicted in FIGS. 14A-14C, the edge frames employed are double-“U”-shaped edge frames 136 (“W-shaped edge frames”)—each of which capable of receiving two surfboard edges in parallel—rather than “U” shaped edge frames 131. As illustrated, surfboard 1 is packaged and secured vertically in the packaging 100 by two pairs of W-shaped edge frames 136, with foam pad cushions 161 placed between each frame 136 and the rails of surfboards 1 and 2. Each pair of W-shaped edge frames 131 is secured together by fastening straps 170, and is secured in the outer enclosure 101 with stabilizers 180 at the front and back ends, respectively. In some embodiments, as illustrated in FIG. 15C, additional foam pad cushions 161 may be positioned between each W-shaped edge frame 136 and the outer enclosure 101 at the external bottom (i.e., across from the bottom of the internal W) and/or at the external sides (i.e., across from the sides of the internal W) of frame 136. Glue or other fastening methods known in the art may be used to further secure various components together.

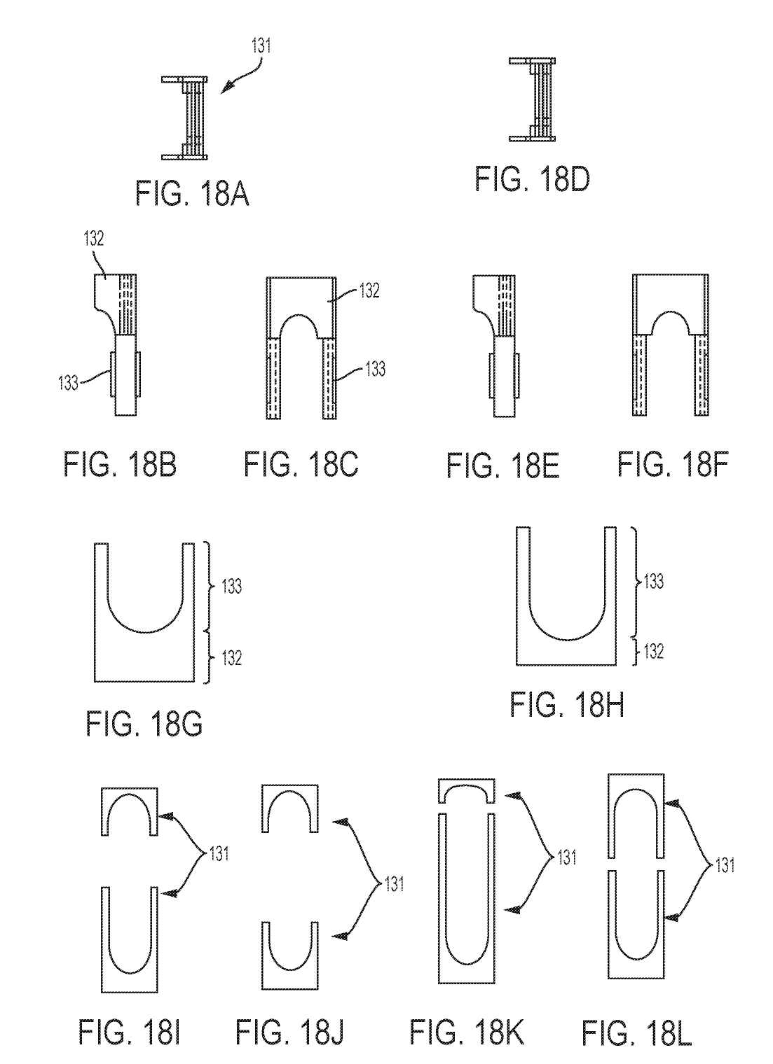

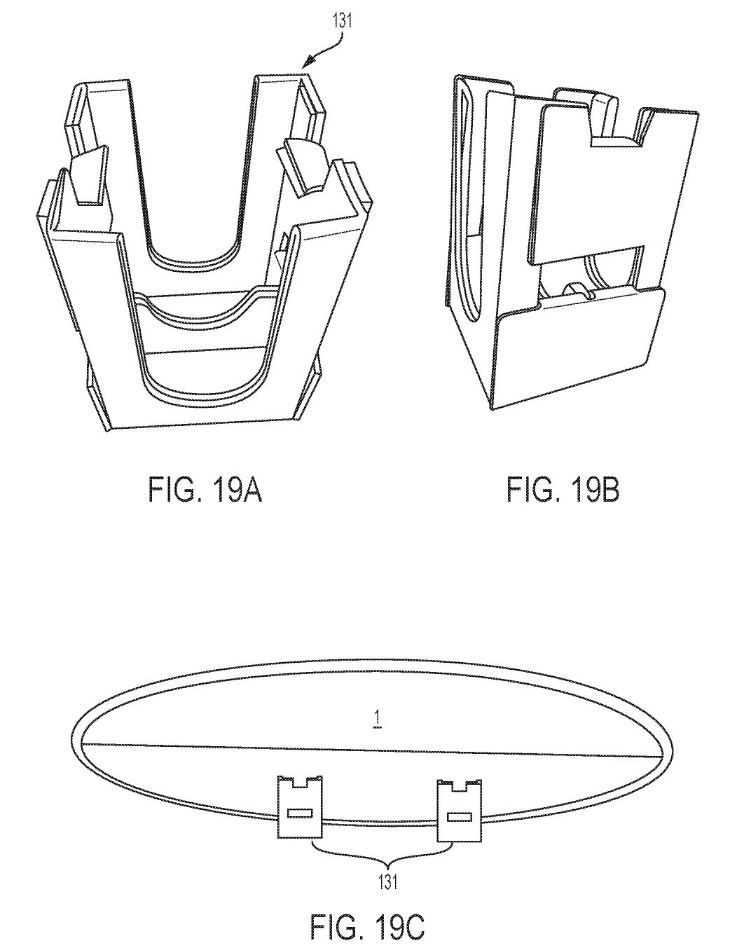

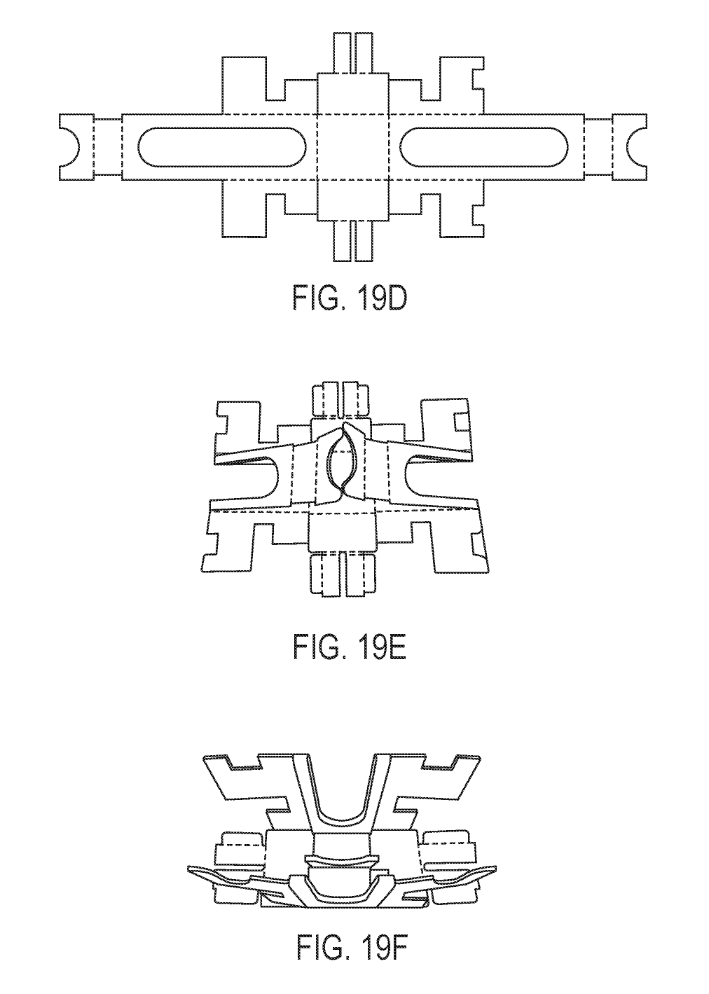

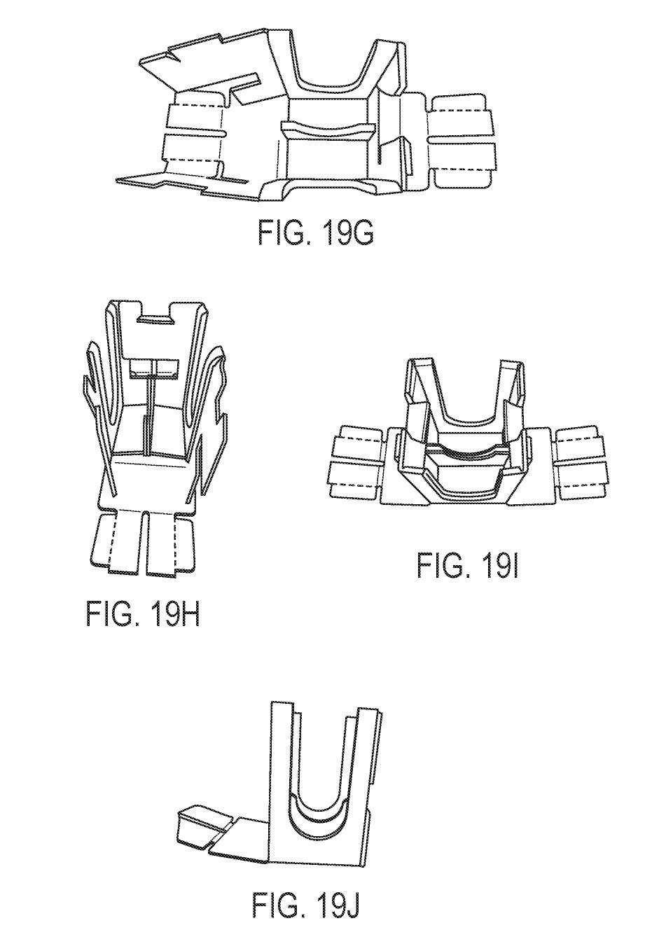

FIGS. 18A-19C depict various additional embodiments of “U”-shaped edge frames. The frames may be constructed in a multilaminar, composite, or molded fashion. For example, if the frames are made of cardboard, multiple layers of cardboard material may be glued together to form a sandwiched structure.

In certain embodiments, for example shown in FIGS. 18A-18F, the “U”-shaped edge frames have (i) a top portion 133 that is multilaminar, containing multiple layers of material that are adhered in a direction that is perpendicular to the length of the surfboard, and (ii) a bottom portion 132 that is also multilaminar, but containing multiple layers of material that are adhered in a direction that is parallel to the length of the surfboard. The respective directions of multilaminarity may be selected to provide suitable strength based on the mechanical stresses, such as normal stresses and shear stresses, that are produced by the weight of the objecting being packaged and the external and internal forces produced in the packaging during shipping. Furthermore, the top portion 133 of the frame 131 preferably includes two arms and may flare outward (either symmetrically or asymmetrically) to provide increased surface area at which the frame can press against and be supported by another surface, such as an inner surface of the outer enclosure 101. For example, the contact portion of the frame 131 may flare outward in the lengthwise direction of a surfboard 1 to enhance stability of support for the surfboard 1.

In one version, symmetric frames 131 may be provided. FIGS. 18D-18F illustrate respective top, front, and side views of an exemplary symmetric “U”-shaped edge frame. In another version, however, asymmetrically-shaped frames 131 may be provided. FIGS. 18A-18C illustrate respective top, front, and side views of an exemplary asymmetric “U”-shaped edge frame. The symmetry or asymmetry may preferably be along the depth direction of a surfboard. Asymmetric frames 131 may be used, for example, to package a surfboard that is asymmetrically-shaped in its depthwise dimension, or alternatively in its lengthwise or widthwise dimensions. For example, different surfboards may have different rocker shapes, such as different nose rocker and tail rocker angles. Asymmetric, symmetric, or a combination of both types of frames may be used for a snug fit and/or to minimize unused space inside the package or the size of the outer enclosure 101 according to the shape of the object being packaged, such as a surfboard rocker and/or rail shape. For example, asymmetric frames 131 may be used near/at the nose and tail of the surfboard while symmetric frames 131 may be used near/at the middle of the surfboard.

Symmetric frames 131 may be used if it is desirable to use standardized frames for various types (e.g., shapes and/or sizes) of objects to be packaged or objects whose shape and/or size is unknown at the time the packaging frames are fabricated. This may be advantageous, for example, if it there are restrictions on the size of the package or the differences in shipping cost between differently sized packages are insignificant in comparison to the convenience of having standardized packaging materials such as the frames.

Asymmetric frames 131 may, for example, be utilized to minimize unused space inside the package or the size of the package (e.g., outer enclosure) according to the shape of the object being packaged. In the example, the frame types may be fabricated or selected according to the specific type of object to be packaged. This may be advantageous, for example, if it there are restrictions on the size of the package or the differences in shipping cost between differently sized packages are significant in comparison to any possible inconvenience in fabricating or obtaining asymmetric frames 131 that fit the specific type of object being packaged.

Furthermore, the curved or angled inner surface of a “U”-shaped edge frame 131 (e.g., the “U”-shaped inner surface shown above) may be angled, curved, or otherwise shaped along a length of the object based on the shape of the object. For example, the inner surface of the frame may be curved (e.g., as a “saddle surface”) along the lengthwise direction of the surfboard to accommodate the surfboard's rail and rocker curvatures.

FIGS. 18G and 18H illustrate that the bottom portion 132 of a frame 131 may be raised or lowered to, for example, snugly fit a surfboard 1 or other packaged object and to help minimize unused space inside the outer enclosure 101. For example, for a surfboard 1 (or other elongated, substantially planar object) having a greater width, frames 131 that will be abutted against the rails of the surfboard may have a base that is lowered, such as shown in FIG. 18H, to accommodate the surfboard or other object. In another example, if the surfboard has a smaller width, the frames 131 may have a bottom portion 132 that is raised, such as shown in FIG. 18G.

FIGS. 18I-18L illustrate additional examples of shapes suitable for “U”-shaped edge frames 131, which may be sandwiched around the object being packaged. Moreover, the frames 131 relative to the rest of the packaging may be disposed based on one or more of the length, width, and other dimensions of the outer enclosure 101, the infrastructure, or the object being packaged. For example, in the case of packaging a surfboard, the frames 131 may be disposed in part based on the rocker (shape and dimensions).

FIGS. 19A and 19B, respectively, are side perspective and front perspective view of an embodiment of a “U”-shaped edge frame 131. Advantageously, this embodiment may be formed by simply cutting and folding cardboard, but in other versions may utilize other semi-rigid and foldable materials such as plastics. In certain exemplary embodiments, neither glue, staples, nor another adhesive is necessary for assembly of this type of frame 131. As can be viewed most clearly in FIG. 19A, this embodiment of “U”-shaped edge frame 131 may have three “U”-shaped inner surfaces that are two layers thick, in which to receive an edge of a surfboard 1 or another object. Other versions may have 1, 2, 4 or more such surfaces and/or such surfaces may comprise one, three or more layers. FIG. 19C depicts two folded cardboard frames 131 holding a surfboard 1. FIG. 19D depicts an exemplary cut piece of cardboard which may be folded into a frame 131, and FIGS. 19E though 19J illustrate exemplary folding steps that may be taken to produce the frame 131 of FIGS. 19A-19C.

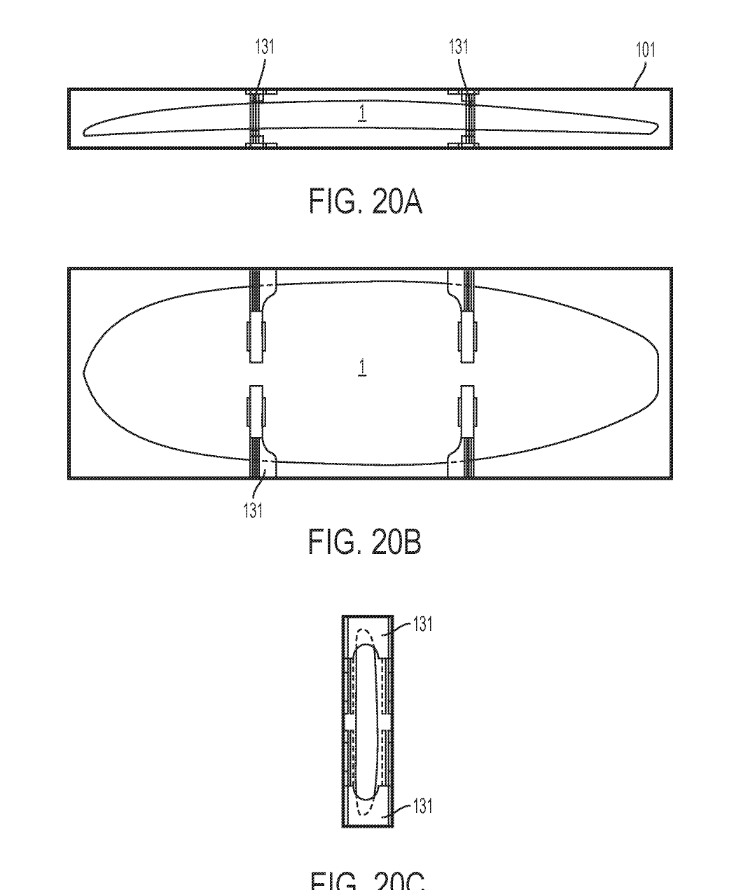

FIGS. 20A-20C illustrate respective top, front, and side views of an embodiment of vertical packaging 100 of a single surfboard 1, wherein the top, front, and side surfaces, respectively, of outer enclosure 101 are omitted for the purpose of illustration. The figures depict a pair of asymmetric “U”-shaped edge frames 131 of the type shown in FIGS. 18A-18C on each rail of the surfboard to secure it, but other embodiments of frames 131 may be used. Fastening straps 170 are not depicted and may be omitted or included in alternate versions. Stabilizers 180 are not depicted, and may be omitted certain embodiments, particularly where frames 131 have a substantial width (e.g., along the longitudinal axis of the surfboard 1) and/or are directly affixed to the outer enclosure 101 or other elements of the infrastructure with glue or the like. In yet other embodiments, more the four “U”-shaped edge frames 131—for example six or eight frames 131—may be used to secure a surfboard 1 or other object.

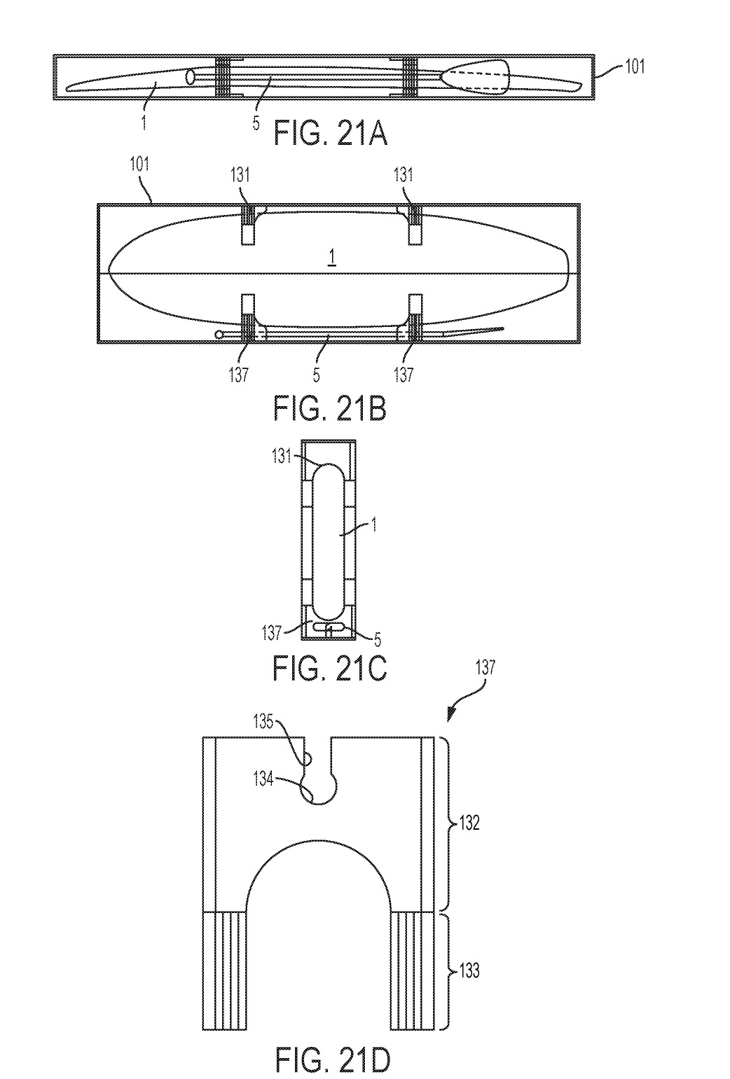

FIGS. 21A-21C depict cross-sectional top, front, and side views, respectively, of an illustrative example of vertical packaging 100 for a single surfboard 1, such as an SUP, and another object, such as a paddle 5, wherein the top, front, and side surfaces, respectively, of outer enclosure 101 are omitted for the purpose of illustration. This embodiment is similar to that depicted in FIGS. 20A-20C, but pair of the “U”-shaped frames 131 are apertured “U”-shaped frames 137, for example, as depicted in detail in FIG. 21D. (It may be noted that frames 131 depicted in FIG. 21A-21C are symmetrical, but other embodiments of frames 131 may be used.) Each apertured “U”-shaped frame 137 has an aperture, such as a slit 135 and/or a hole 134, that permits, for example, a pole of an accessory, such as a water paddle 5, to be held therein. For example, as can be best seen in FIG. 21B, two apertured “U”-shaped frames 137 on the same side of the packaging may include apertures such that they are adapted to jointly hold a paddle 5 by its pole. FIG. 21D depicts a frame 137 with a slit 135 and a hole 134 in the bottom portion 132. In certain embodiments, the width of the slit 135 may be smaller than the diameter of hole 134 so that a pole of paddle 5, for example, may be slid into the hole via the slit, but will rest within the larger hole unless forced back through the slit. The paddle 5 may be further secured in an aperture with packing tape or the like. In certain embodiments, the slit may have a width of approximately 1 inch and the hole may have a diameter of approximately 1.25 inches. In one example embodiment configured to hold an SUP and paddle 5, packaging 100 may have dimensions of about 126″×38″×10″.

In alternative embodiments, the aperture may be located elsewhere on the apertured “U”-shaped frame 137, such as at the top portion 133. This may be suitable, for example, when the arms of a “U”-shaped frame 131 are wide enough and/or the material around the aperture is robust enough to accommodate the aperture and structurally retain the accessory during jostling and/or shipping.

As depicted in FIG. 22, components of the infrastructure that hold the object being packaged—such as the edge frames—may have alternative constructions and shapes that are adapted to hold the object. For example, the edge frames may be substantially wedge-shaped along one cross-section to snugly abut the front and rear sections of a surfboard rail. Such wedge frames 139 may optionally be adhered to the outer enclosure by glue, or alternatively a non-permanent adhesive type such as Velcro such that the positions and/or orientations of the frames can be adjusted. In certain embodiments, these frames may be made of a deformable material to act as cushions, instead of cardboard or plastic. For example, these frames may be made of a polyurethane foam material. In this manner, the same frames may deform to adapt to a range of differently sized or shaped objects, such as different types of surfboards (e.g., surfboards having differently angled rails or rockers). This may be beneficial in allowing standardized packaging 100 to be used (or, in some versions, reused) for different shapes and/or sizes of objects.

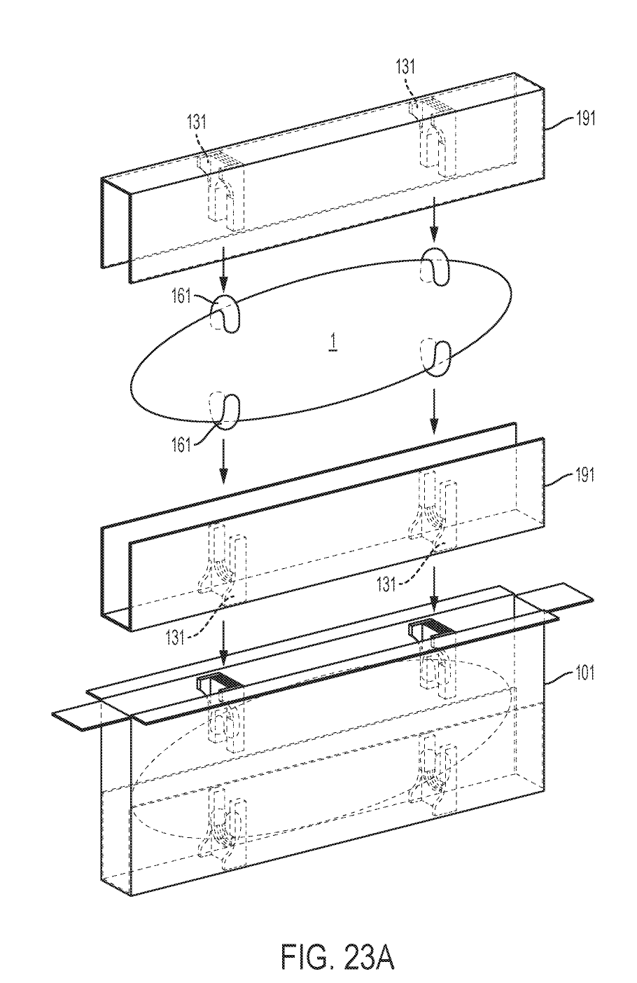

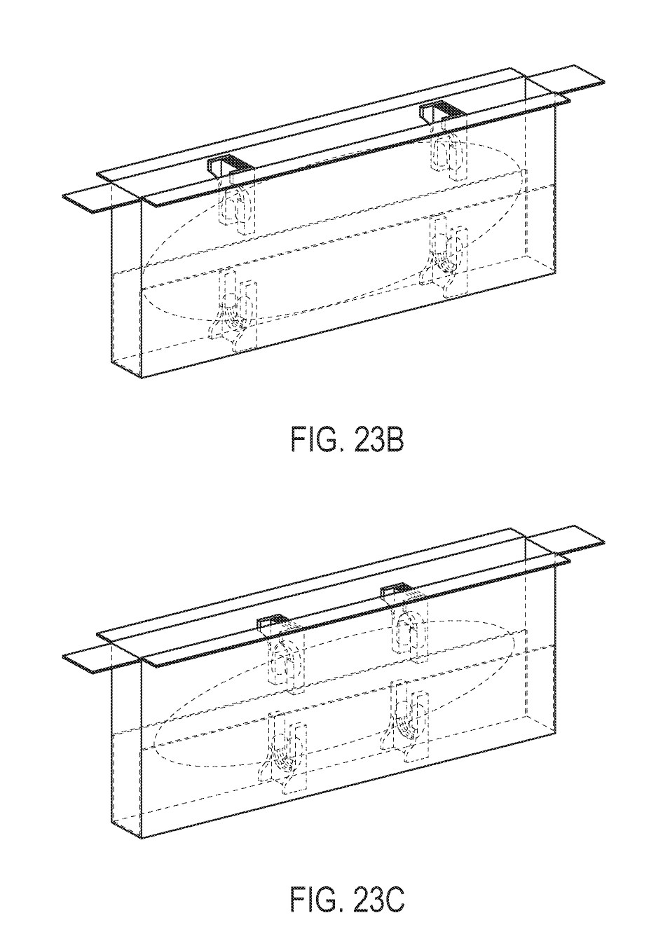

FIG. 23A illustrates an embodiment of surfboard packaging 100 including horizontal bracket inserts 191 and “U”-shaped edge frames 131, and depicts steps of an exemplary method of assembling such surfboard packaging 100. First, a pair of “U”-shaped edge frames 131 is glued or otherwise affixed to the top and bottom horizontal bracket inserts 191. The position or structure of the “U”-shaped edge frames 131 may be dependent on the size of the surfboard. Second, foam pad cushions 161 (or another type of cushion) are attached to the inner surface of frames 131 and/or the rails of the surfboard 1 in line with the frames 131. Third, the bottom bracket insert 191 is placed into outer enclosure 101. Fourth, surfboard 1 is mounted in frames 131 of the bottom bracket insert 191 in outer enclosure 101. Fifth, the top bracket insert 191 is placed into outer enclosure 101, thereby mounting its frames 131 onto the surfboard. Sixth, the outer enclosure 101 may be sealed.

As depicted in FIG. 23C, a smaller surfboard 1 may be held by edge frames that are spaced closer together due to the shorter length of the surfboard 1 and according to the shape of the surfboard. Stated another way, frames 131 placed on one side of a surfboard may be moved closer together to engage with a wider (more central) portion of the surfboard for a tighter fit in the packaging 100. Additionally or alternatively, as discussed above with respect to FIGS. 18G and 18H, the bottom portion 132 of a “U”-shaped frame 131 may be higher to hold the surfboard due to the smaller width of this surfboard.

Conversely, as depicted in FIG. 23B, a larger surfboard may be held by edge frames that are spaced farther apart due to the greater length of the surfboard and according to the shape of the surfboard. Stated another way, two frames 131 placed on one side of a surfboard may be moved farther apart to narrower portions of the surfboard for a looser fit in the packaging 100. Additionally or alternatively, as discussed above with respect to FIGS. 18G and 18H, the bottom portion 132 of a “U”-shaped frame 131 may be shorter to hold the surfboard due to the greater width of this surfboard. Thus, the edge frames may be shaped and/or positioned based on the dimensions of the surfboard 1.

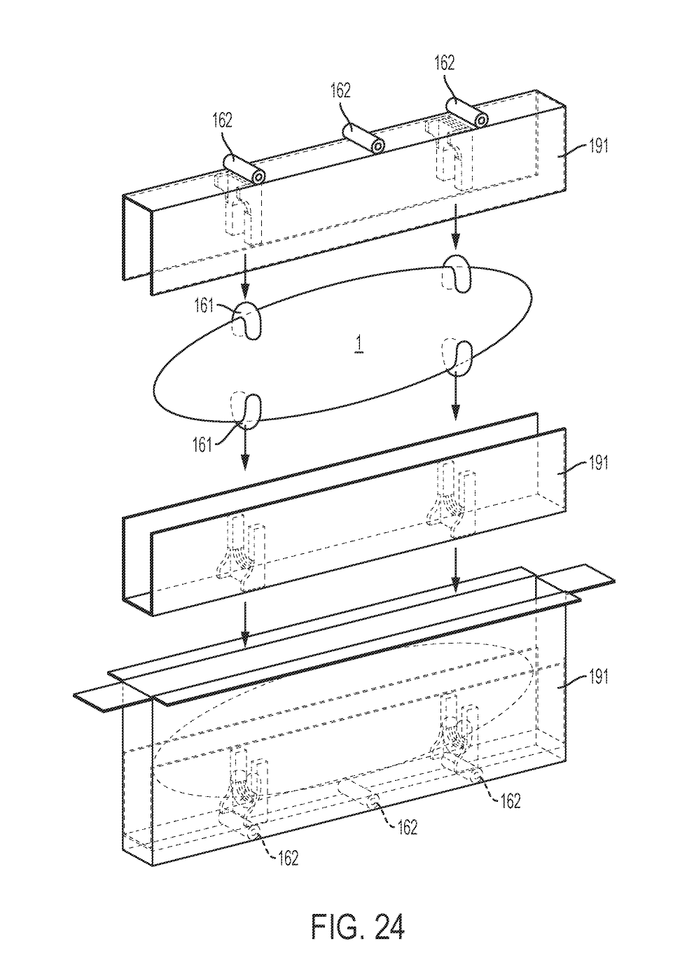

FIG. 24 illustrates an embodiment of surfboard packaging 100 that is similar to that of FIG. 23A, but also comprises cushions disposed between horizontal bracket inserts 191 and outer enclosure 101. The cushions may be, for example, foam pads and/or be substantially cylindrically symmetric roller cushions 162. In some versions, the bracket inserts 191 and frames 131 may be shortened (e.g., vis-à-vis FIG. 23A) to allow space for the roller cushions 162.

FIG. 24 also depicts steps of a method of assembling such surfboard packaging 100. First, a pair of “U”-shaped edge frames 131 is glued or otherwise affixed to the top and bottom horizontal bracket inserts 191. Second, foam pad cushions 161 (or another type of cushion) are attached to the inner “U”-shaped surface of frames 131 and or the rails of the surfboard 1 in line with the frames 131. Third, roller cushions 162 are placed at the bottom of the outer enclosure 101. Fourth, the bottom bracket insert 191 is placed into outer enclosure 101 on top of cushions 162. Fifth, the surfboard 1 is mounted in frames 131 of the bottom bracket insert 191 in outer enclosure 101. Sixth, the top bracket insert 191 is placed into outer enclosure 101, thereby mounting its frames 131 onto the surfboard. Seventh, roller cushions 162 are placed on top of top bracket insert 191. Eighth, the outer enclosure 101 may be sealed.

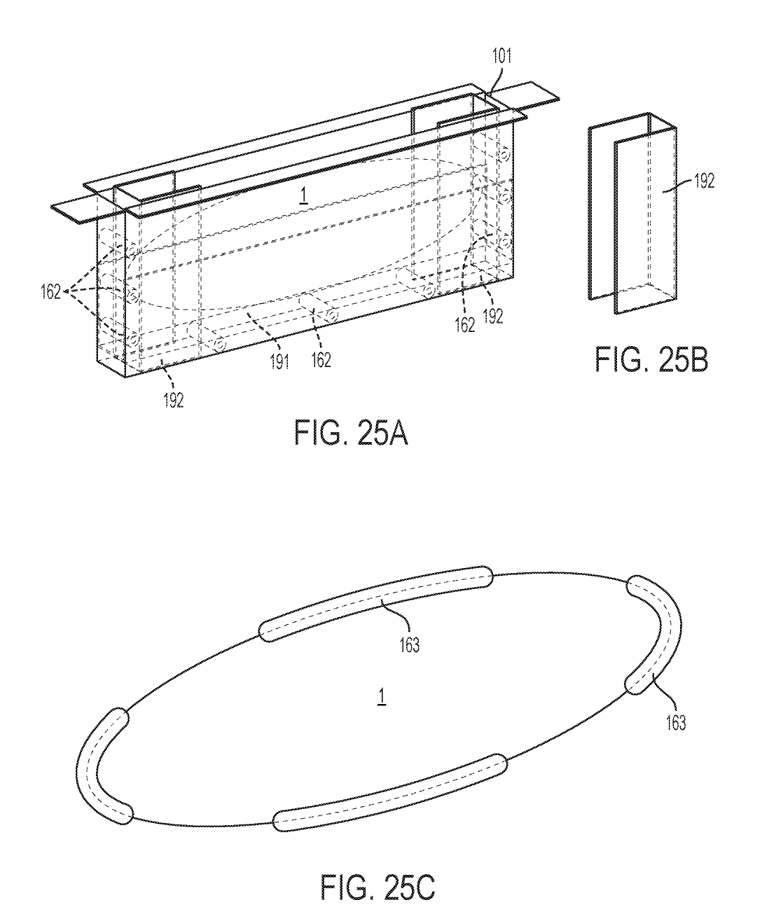

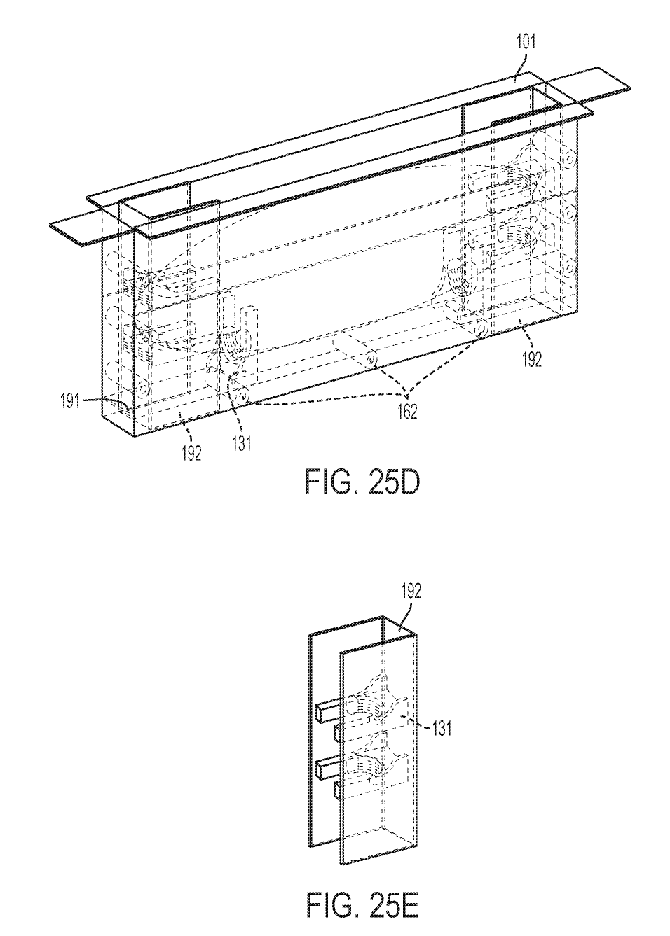

FIG. 25A illustrates an embodiment of surfboard packaging 100 where a set of vertical bracket inserts 192 are perpendicularly disposed in relation to a set of horizontal bracket inserts 191 and where the edge frames are omitted. For example, the horizontal and vertical sets of bracket inserts 191, 192 may be pairs, respectively. For ease of illustration, the top horizontal bracket insert 191 and abutting roller cushions 162 are omitted from FIG. 25A. Horizontal bracket inserts 191 may fit inside the space formed by the vertical bracket inserts 192, or vice versa. Alternatively, the horizontal and vertical sets of bracket inserts 191, 192 may intersect, such as by slits provided in at least one of the pairs of bracket inserts. Furthermore, roller cushions 162 (or another type of cushion) may be positioned between the bracket inserts and outer enclosure 101. The bracket inserts may be shortened to allow space for the roller cushions 162. FIG. 25B illustrates an embodiment of vertical bracket insert 192, consistent with FIG. 25A.

FIG. 25C illustrates an example of elongated edge cushions 163 placed along both lengthwise sides of a surfboard rail and along the nose and tail edges of the surfboard. Such an arrangement may be used, for example, to decrease the amount and complexity of packaging 100 by eliminating some or all of the frames. A surfboard 1 protected with elongated edge cushions 163 may be used, for example, with the embodiment depicted in FIG. 25A to afford additional protection during shipping, packing, and/or storage.

FIG. 25D illustrates an embodiment of packaging 100, similar to that of FIG. 25A, but where the edge frames are incorporated. For example, a pair of “U”-shaped edge frames 131 may be included on each of horizontal and vertical bracket inserts 191, 192. For ease of illustration top horizontal bracket insert 191, its frames 131, and abutting roller cushions 162 are omitted from FIG. 25E. FIG. 25E illustrates an embodiment of vertical bracket insert 192 with a pair of “U”-shaped edge frames 131, consistent with FIG. 25D.

The embodiment depicted in FIG. 25D may be assembled, for example, with the following exemplary steps. The bracket inserts and frames 131 may be assembled, preferably including pad cushions 161. Roller cushions 162 may be placed at the bottom of outer enclosure 101. The bottom bracket insert 191 may be placed inside outer enclosure 101. The two vertical bracket inserts 191 may be positioned within or intersecting the first bottom bracket insert to cover the nose and tail of the surfboard. Roller cushions 162 may be positioned between the vertical bracket inserts 191 and outer enclosure 101. During this step, and the cushions 162, in some embodiments, may roll as the vertical bracket inserts 191 are installed. The top bracket insert 192 may be placed on top of the other three bracket inserts, followed by roller cushions 162. Then, outer enclosure 101 may be sealed. Surfboard 1 may be inserted following placement of the bottom horizontal bracket insert 191 or, alternatively, after placement of the two vertical bracket inserts 192.

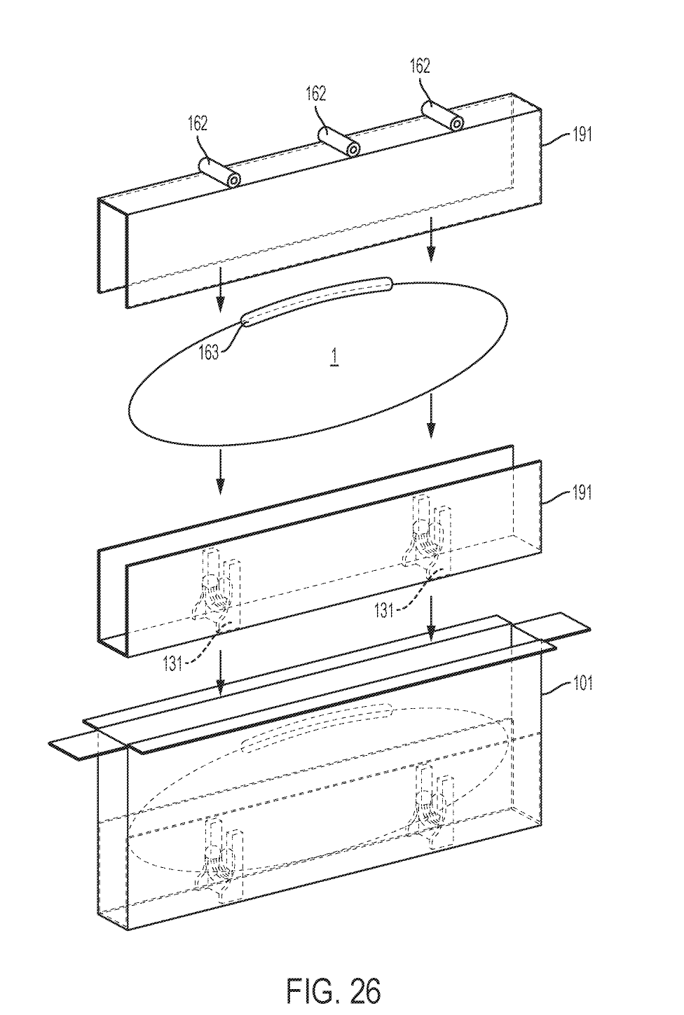

FIG. 26 illustrates an embodiment of packaging 100 in which the infrastructure is asymmetric with respect to the two opposite rails of a surfboard being packaged, and depicts steps of an example method of its assembly. This embodiment may be considered a hybrid of the embodiments depicted in FIGS. 23A, 25C, and 25D. For example, a single elongated edge cushion 163 may be placed along the top side surfboard rail without any frames 131 on that side. Such an arrangement may be used, for example, if it is expected that top side will be kept upright during shipping and/or will not be expected to receive as much impact force as the bottom side.

The embodiment depicted in FIG. 26 may be assembled with the following exemplary steps: First, a pair of “U”-shaped edge frames 131 may be glued or otherwise affixed to the bottom horizontal bracket insert 191. Second, foam pad cushions 161 (or another type of cushion) may be attached to the inner surface of frames 131 and/or the lower rail of surfboard 1 in line with the frames 131. Third, the bottom bracket insert 191 may be placed into outer enclosure 101. Fourth, surfboard 1 may be mounted in frames 131 of the bottom bracket insert 191 in outer enclosure 101. Fifth, a single elongated edge cushion 163 may be placed along the top side surfboard rail. Sixth, the top horizontal bracket insert 191 may be disposed within the outer enclosure 101 on top of the surfboard 1. Seventh, roller cushions 162 may be placed upon top horizontal bracket insert 192. Eighth, outer enclosure 101 may be sealed.

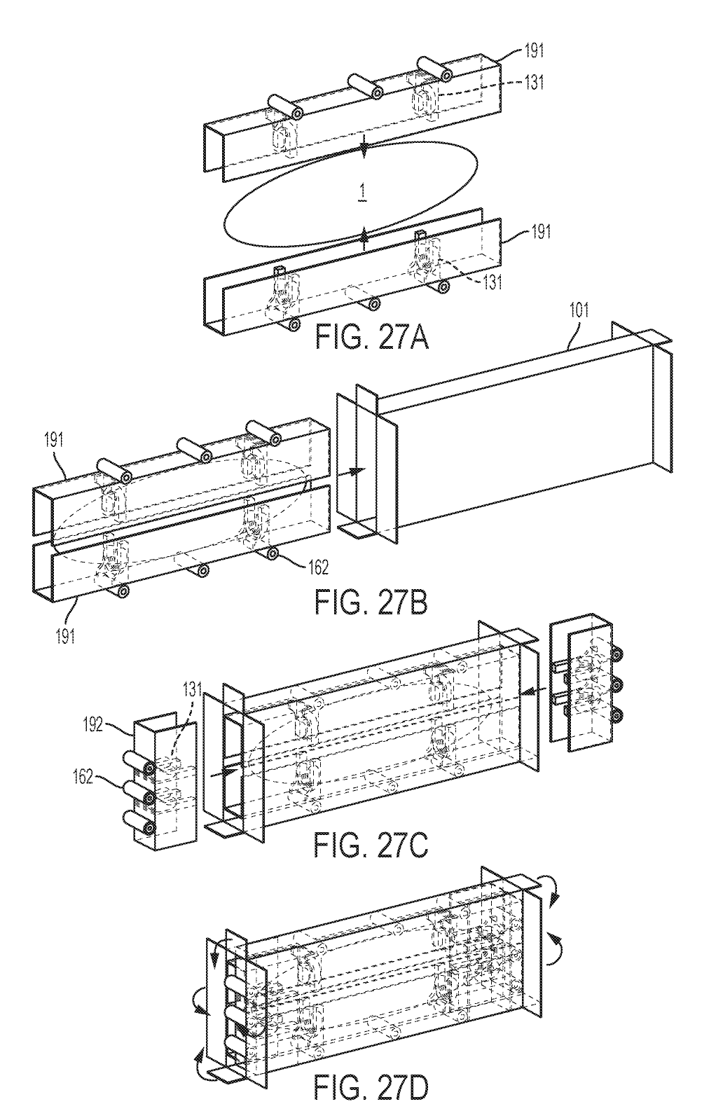

FIGS. 27A-D illustrate a method of assembling an embodiment of surfboard packaging 100 that is similar to that of FIG. 25A. However, in FIGS. 27A-D, components of infrastructure are loaded sideways into outer enclosure 101. Some infrastructure components may be loaded sideways from one side of the box while others are loaded from the other side.

One exemplary method of assembly consistent with FIGS. 27A-D is as follows: First, a pair of “U”-shaped edge frames 131 may be glued or otherwise affixed to the top and bottom horizontal bracket inserts 191. Second, foam pad cushions 161 (or another type of cushion) may be attached to the inner surface of frames 131 and/or the rails of the surfboard 1 in line with the frames 131. Third, as shown in FIG. 27A, top and bottom horizontal bracket inserts 191 may be securely mounted onto surfboard 1 via frames 131. Fourth, as shown in FIG. 27A, surfboard 1 and the partially assembled infrastructure may be inserted into outer enclosure 101 along with roller cushions 162 that are positioned on the top and bottom, respectively of the partially assembled infrastructure. Fifth, a pair of “U”-shaped edge frames 131 may be glued or otherwise affixed to the vertical bracket inserts 192. Sixth, foam pad cushions 161 (or another type of cushion) may be attached to the inner surface of frames 131 and/or the nose and tail of surfboard 1 in line with the frames 131. Seventh, as shown in FIG. 27C, vertical bracket inserts 192 may be securely mounted onto surfboard 1 via frames 131. This occurs as the vertical bracket inserts 192, roller cushions 162, are slid into outer enclosure 101. Eighth, outer enclosure 101 may be sealed.

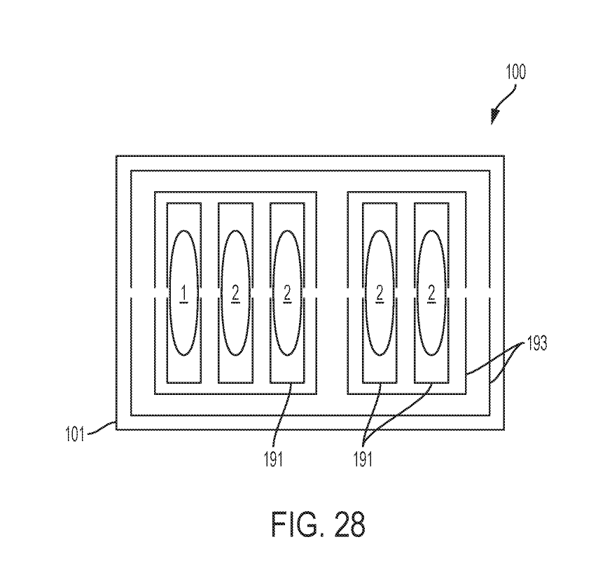

FIG. 28 depicts a schematic side view of an embodiment of packaging 100 for multiple surfboards that includes layered bracket inserts 193, in addition to horizontal bracket inserts 191. In this illustration, each of individual surfboards 1 and 2 is surrounded by a first pair of inserts, namely top and bottom horizontal inserts 191. A pair and a triplet of such insert-surrounded surfboards may be, in turn, respectively surrounded by second pairs of larger inserts, namely, top and bottom layered bracket inserts 193. In this example, a set (such as the pair shown) of such doubly surrounded surfboards may be further surrounded by a third pair of top and bottom layered inserts 193. Although more or fewer layered inserts 193 may be including in packaging 100, it is contemplated that outer enclosure 101 surrounds the outermost bracket inserts. For ease of illustration, the frames, cushions, and other infrastructure components are omitted from the FIG. 28, even though their presence is contemplated consistent with this description.

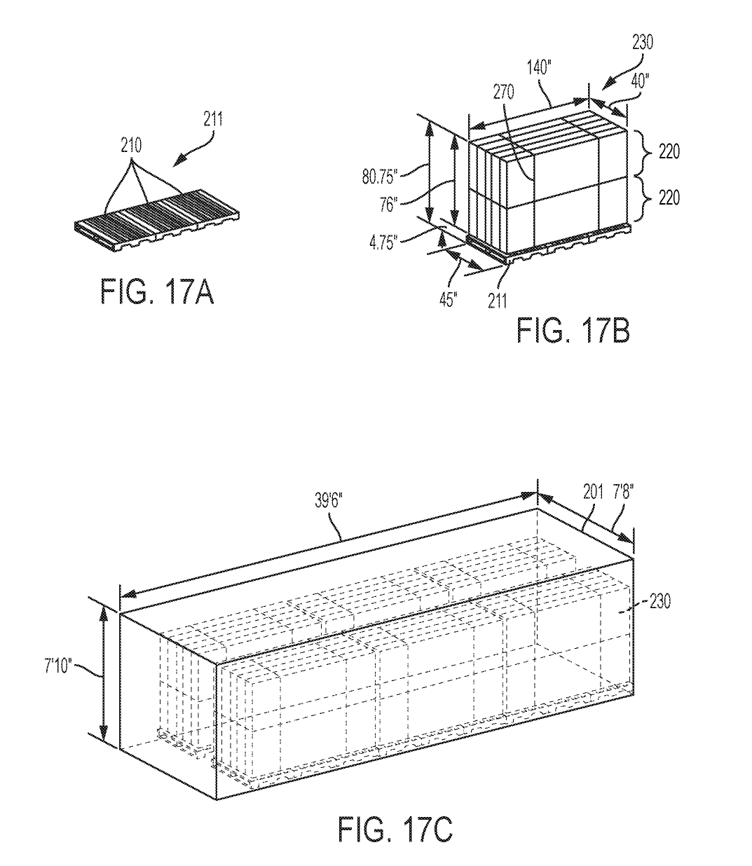

With reference to FIGS. 17A-17C, further described are methods of packing and loading packaging 100, such as through the use of pallets 210 and shipping or freight containers 201, to, for example, further protect surfboards or other objects from damage during transportation and storage.

Examples of methods of preparing and loading packaging 100 for shipping are discussed below. As shown in FIG. 17A, a group of three pallets 210, in one example having dimensions of about 48″×40″×4.75″, may be connected by bolts to form a pallet assembly 211. In some embodiments, a set of five outer enclosures 101 are lightly glued together to form a package assembly 22; this package assembly 22 may be glued onto the pallet assembly 211; five surfboards 1, as well as corresponding infrastructure 110, are inserted and held in the five enclosures 101; and each packaging 100 is completed by closing the enclosures 101 with fastening devices, such as, large box wire staples or adhesive tape. In other embodiments, a set of five already completed and sealed packages 100 may be lightly glued or otherwise joined together to form a package assembly 22. Large box wire straps 270 may be used to secure a second package assembly 220 on the top of the lower package assembly. FIG. 17B depicts a shipping unit 230 comprising two package assemblies 220 and a pallet assembly 211. Then, as shown in FIG. 17C, a plurality of shipping units 230 may be loaded into an approximately 40-foot-long freight container 201 by forklift. An exemplary freight container 201 may hold six shipping units, which correspond to 12 pallet assemblies 230 in this example. Exemplary dimensions as shown in FIGS. 17A-17C may support loading and fitting sixty (60) packages 100 into one 40-foot-long container.

In some versions, one or more cushions are provided on the pallet(s) 210, such as under the packaging 100, to protect the packaging 100 and the objects inside from impact forces and/or to protect the packages from abrasion. Additionally or alternatively, a handle of a package 100 may be disposed on the side facing the pallet 210. The handle may prevent the packaging from being crushed by a forklift during loading. The handle can be used to pull out packages and forklift the packages onto a pallet.

Pallets 210 or pallet assemblies 211 that are larger than packaging 100 or package assemblies 220 may optionally be used. In such embodiments, packaging 100 or package assemblies 220 do not hang over the pallets 210 or pallet assemblies 211, and thereby may prevent accidental crushing by forklift pushing.

Although the foregoing embodiments have been described in detail by way of illustration and example for purposes of clarity of understanding, it will be readily apparent to those of ordinary skill in the art in light of the description herein that certain changes and modifications may be made thereto without departing from the spirit or scope of the appended claims. For example, one of ordinary skill in the art may modify or change the parameters used in the examples, such as the dimension, aspect ratio, number of layers, and position and number of slots/slits, or combine various features of the examples, without departing from the scope of the invention. It is also to be understood that the terminology used herein is for the purpose of describing particular aspects only, and is not intended to be limiting, since the scope of the present invention will be limited only by the appended claims.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only,” and the like in connection with the recitation of claim elements, or use of a “negative” limitation. As will be apparent to those of ordinary skill in the art upon reading this disclosure, each of the individual aspects described and illustrated herein has discrete components and features which may be readily separated from or combined with the features of any of the other several aspects without departing from the scope or spirit of the disclosure. Any recited method can be carried out in the order of events recited or in any other order that is logically possible. Accordingly, the preceding merely provides illustrative examples. It will be appreciated that those of ordinary skill in the art will be able to devise various arrangements which, although not explicitly described or shown herein, embody the principles of the disclosure and are included within its spirit and scope.

Furthermore, all examples and conditional language recited herein are principally intended to aid the reader in understanding the principles of the invention and the concepts contributed by the inventors to furthering the art, and are to be construed without limitation to such specifically recited examples and conditions. Moreover, all statements herein reciting principles and aspects of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary configurations shown and described herein.

In this specification, various embodiments have been described with reference to the accompanying drawings. It will be apparent, however, that various other modifications and changes may be made thereto and additional embodiments may be implemented. The specification and drawings are accordingly to be regarded in an illustrative rather than restrictive sense.

We claim:

1. An apparatus for packaging at least one surfboard, the apparatus comprising:
an outer enclosure; and
a plurality of edge frames supported directly or indirectly by the outer enclosure, the edge frames being configured to support the surfboard, directly or indirectly.

2. The apparatus of claim 1, further comprising:
a plurality of stabilizers affixed to the outer enclosure,
wherein:
the plurality of edge frames comprise at least a first edge frame and a second edge frame;
the first edge frame abuts at least two of the plurality of stabilizers; and
the second edge frame abuts at least two of the plurality of stabilizers.

3. The apparatus of claim 2, wherein each of the plurality of stabilizers is affixed to the outer enclosure with Velcro.

4. The apparatus of claim 1, wherein the plurality of edge frames comprises at least a first edge frame, a second edge frame, a third edge frame, and a fourth edge frame; and each of the first, second, third, and fourth edge frames are wedge-shaped.

5. The apparatus of claim 1, wherein
the plurality of edge frames comprises at least a first edge frame and a second edge frame;
each of the first and second edge frames are U-shaped frames and each of the first and second edge frames comprises a top portion and a bottom portion; and
at least the bottom portion of each of the first and second edge frames forms at least one inner surface configured to directly or indirectly engage with an edge of the surfboard.

6. The apparatus of claim 5, wherein
the top portion of each of the first and second edge frames comprises a first plurality of cardboard layers that are glued together;
the bottom portion of each of the first and second edge frames comprises a second plurality of cardboard layers that are glued together; and
the first and second plurality of cardboard layers are oriented perpendicularly to one another.

7. The apparatus of claim 6, wherein
the first edge frame is symmetrical along at least one axis; and
the second edge frame is symmetrical along at least one axis.

8. The apparatus of claim 6, wherein at least the first edge frame is asymmetrical along all of its axes.

9. The apparatus of claim 5, wherein:
the first edge frame comprises a first single piece of folded cardboard; and
the second edge frame comprises a second single piece of folded cardboard.

10. The apparatus of claim 8, wherein the first single piece of folded cardboard is adapted to maintain a folded structure without use of an adhesive.

11. The apparatus of claim 9, wherein the at least one inner surface, which is configured to directly or indirectly engage with an edge of the surfboard, comprises a first inner surface, a second inner surface, and a third inner surface.

12. The apparatus of claim 11, wherein each of the first inner surface, second inner surface, and third inner surface comprise two layers of cardboard.

13. The apparatus of claim 5, further comprising:
a first cushion disposed between the first edge frame and the surfboard; and
a second cushion disposed between the second edge frame and the surfboard.

14. The apparatus of claim 5, wherein the bottom portion of each of the first and second edge frames comprises an aperture that is configured to hold a pole.

15. The apparatus of claim 1, further comprising:
a bottom horizontal bracket insert supported by the outer enclosure, wherein:
the plurality of edge frames comprises at least a first edge frame and a second edge frame; and
the first edge frame and second edge frame are disposed within the bottom horizontal bracket insert.

16. The apparatus of claim 15, further comprising a first set of cushions disposed between the bottom horizontal bracket insert and the outer enclosure.

17. The apparatus of claim 16, further comprising:
a top horizontal bracket insert; and
a second set of cushions disposed between the top horizontal bracket insert and the outer enclosure.

18. The apparatus of claim 17, further comprising:
a third set of cushions disposed between the object and the top horizontal bracket insert,
wherein the third set of cushions comprises an elongated edge cushion.

19. The apparatus of claim 17, wherein:
the plurality of edge frames further comprises a third edge frame and a fourth edge frame;
the first edge frame and the second edge frame are affixed within the bottom horizontal bracket insert;
the third edge frame and the fourth edge frame are affixed within the top horizontal bracket insert; and
the surfboard is secured between the first edge frame and the second edge frame on a bottom edge side, and between the third edge frame and the fourth edge frame on a top edge side.

20. The apparatus of claim 19, further comprising:
a first vertical bracket insert; and
a second vertical bracket insert,
wherein:
the first vertical bracket insert either intersects with or is disposed at least partially within the top horizontal bracket insert and the bottom horizontal bracket insert; and
the second vertical bracket insert either intersects with or is disposed at least partially within the top horizontal bracket insert and the bottom horizontal bracket insert.
